(19) United States
(12) Patent Application Publication
(10) Pub. No.: US 2026/0236150 A1
(43) Pub. Date: Aug. 13, 2026

(54) SYSTEMS AND METHODS FOR MANAGING ELECTRONIC DOCUMENTS

(71) Applicant: FACTIFY TECHNOLOGIES INC., Dover, DE (US)

(72) Inventors: Matan Gavish, Givat Ada (IL); Gil Asher, Binyamina (IL); Royi Noiman, Tel Aviv (IL); Rinat Freida Sorkin, Karmiel (IL); Orit Balicer Tsur, Ramat Gan (IL); Tal Koelewyn, Modi'in (IL)

(21) Appl. No.: 19/640,145

(22) Filed: Apr. 6, 2026

Related U.S. Application Data
(63) Continuation of application No. PCT/US2025/034262, filed on Jun. 18, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.
(60) Provisional application No. 64/002,016, filed on Mar. 10, 2026.
(60) Provisional application No. 64/010,751, filed on Mar. 19, 2026.

(51) Int. Cl. G06F 3/04842; G06F 3/0483; G06F 16/93

(52) U.S. Cl. CPC G06F 3/04842; G06F 3/0483; G06F 16/93

(57) ABSTRACT

The aspects described herein pertain at least to a method for identifying and presenting electronic documents and digital content instances linked to these documents in accordance with a framework. The method includes receiving, at an electronic document provisioned as digital infrastructure, a query to access the electronic document, identifying, using the query, a framework for presenting the electronic document, and outputting metadata of the electronic document for presenting on a user interface, according to the framework, at least one digital content instance of the electronic document.

### PRIORITY CLAIMS TO RELATED APPLICATIONS

This application is a continuation application of and claims priority to International Patent Application No. PCT/US25/34262 filed Jun. 18, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, U.S. Provisional Patent Application 64/002,016, filed Mar. 10, 2026, and U.S. Provisional Patent Application 64/010,751, filed Mar. 19, 2026, each of which are incorporated herein in their entirety by these references.

### BACKGROUND

The management of electronic documents is a critical aspect of modern document management and filing systems. Traditional systems rely heavily on hierarchical folder structures and naming conventions, which require significant manual input and organization. Further, searching for documents within these traditional systems may be restrictive, time consuming, and inaccurate, as users may be required to remember specific details about the document, e.g., file name, file number, and so forth. Even minor user errors in a search query may result in inaccurate search results. And even if the search results include a document of interest, users may be required to sort through dozens or even hundreds of file names and user selectable links to identify the document of interest, which results in inefficiencies and significant user frustration.

### SUMMARY

In some aspects, the techniques described herein relate to a computer-implemented method comprising: receiving, at an electronic document provisioned as digital infrastructure, a query to access the electronic document, identifying, using the query, a framework for presenting the electronic document, and outputting metadata of the electronic document for presenting on a user interface, according to the framework, at least one digital content instance of the electronic document.

In some aspects, the techniques described herein relate to a system comprising: a document management hub including at least one physical processor and physical memory comprising computer-executable instructions that, when executed by the at least one physical processor, cause the physical processor to: receive, at an electronic document, a query to access the electronic document, generate, using the query, a framework for presenting the electronic document, and output metadata of the electronic document for presenting on a user interface, according to the framework, at least one digital content instance of the electronic document.

In some aspects, the techniques described herein relate to non-transitory computer-readable medium comprising computer-executable instructions that, when executed by at least one of one or more processors of a computing device, cause the computing device to receive a query to access an electronic document, generate, using the query, a framework for presenting the electronic document, and output metadata of the electronic document for presenting on a user interface, according to the framework, at least one digital content instance of the electronic document.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 depicts a structure of a self-determinative document;

FIG. 2 illustrates a system for managing electronic documents as smart digital objects;

FIG. 3 illustrates a flowchart diagram of a method for presenting digital content instances on a user interface according to a framework;

FIG. 4 illustrates an example digital home page of a document management hub;

FIG. 5A illustrates an example search results page displayed on a viewer;

FIG. 5B illustrates an example digital content instances page that includes multiple digital content instances associated with an electronic document;

FIG. 5C illustrates another example digital content instances page;

FIG. 5D illustrates another example digital content instances page;

FIG. 6A illustrates an advanced search filtering operation implemented by the document management hub;

FIG. 6B illustrates the document management hub outputting an example document content instance present in two virtual folders; and

FIG. 7 illustrates the document management hub presenting search results on the viewer according to another framework.

FIG. 8 illustrates an example visual layout of a digital home page of the document management hub;

FIG. 9 depicts the simultaneous incorporation of multiple changes on an electronic document;

FIG. 10 illustrates a pop-up window that appears adjacent to the electronic document;

FIG. 11 illustrates how the electronic document controls publication of changes;

FIG. 12 depicts a customized dashboard specific to a particular electronic document and which may be accessible only to the owner of the document;

FIG. 13 illustrates the provisioning of an electronic document as digital infrastructure at a particular stage of the document's use;

FIG. 14 illustrates an example software integration or collaboration between an electronic document provisioned as digital infrastructure and a software application or proprietary portal specific to a company;

FIG. 15 illustrates another example visual layout of a home page of the document management hub;

FIG. 16 illustrates the document management hub outputting an example visual layout of a digital binder that includes a number of electronic documents provisioned as digital infrastructure;

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

Electronic documents, also referred to as digital documents, encompass any form of document stored or accessed using a computer or digital medium. Common formats for electronic documents include PS, PDF, and XPS, among others. These documents are represented digitally as files stored on local drives, shared networks, or cloud-based systems. However, traditional methods of managing electronic documents often result in a loss of control for individuals and entities. This loss of control occurs whether the documents are shared externally with third parties or kept internally within an organization.

For example, when a company hires a new employee and grants them access to proprietary information, the company effectively relinquishes control over that information, typically in the form of electronic documents such as PDFs, spreadsheets, word processing files, and forms. Instead of maintaining actual control, the company relies on pseudo-control mechanisms, such as policies, procedures, and legal agreements. If the employee leaves the company and improperly retains or uses these documents, the company must resort to enforcing employment agreements through the legal system. This may involve attempting to recover or destroy the documents or seeking damages for any harm caused by the former employee's misuse of the information.

Similar scenarios occur daily in commerce and other professional relationships. The proliferation of electronic documents creates a chaotic environment where control is tenuous at best. The primary safeguard against misuse is the legal system, which provides a mechanism for enforcing contractual obligations when improper activity has a significant impact. However, litigation is often expensive, uncertain, and disruptive, encouraging parties to comply with contractual obligations to avoid legal disputes.

For instance, in an unsuccessful M&A transaction, one party may inadvertently retain trade secrets from the other side after the deal falls apart. While retaining these documents may breach material erasure provisions of a non-disclosure agreement, the party is unlikely to share the trade secrets with outsiders due to ethical considerations and the fear of legal repercussions. This reliance on pseudo-control—where compliance is partial and breaches are minor enough to avoid litigation—represents the best outcome achievable under the current system.

In virtually every arms-length transaction, confidential information is shared with the expectation that the legal system and a general aversion to litigation will prevent significant misuse. Whether paying for a sandwich with a credit card, engaging in banking or investment activities, consulting with an attorney, completing a real estate transaction, or working with an accountant to prepare taxes, parties routinely share sensitive information and rely on pseudo-control mechanisms to protect it. This reliance on goodwill and the legal ecosystem underscores the limitations of the current system.

There is a clear need for a system that provides actual control over electronic documents, eliminating dependence on the goodwill of others and the costly, uncertain, and distracting process of legal enforcement. Such a system would ensure that document security and integrity are maintained without relying on external safeguards, enabling more efficient and reliable management of sensitive information in modern digital environments.

The process of searching for and identifying documents in traditional methods of managing electronic documents are tedious, resource intensive, and faulty. Users have to search through multiple databases independently and are often constrained by rudimentary boolean search operators, character limitations on search queries, and an unfriendly user interface. The search results that are presented are also often inaccurate. The search process is especially troublesome if users cannot remember specific details about a document such as the file name, a client identification number, a matter number, etc. Further, the manner in which the search results are presented may make it cumbersome for users, requiring many to scroll through dozens or hundreds of documents before identifying the document of interest.

The systems and methods disclosed herein address one or more of the challenges identified above by introducing a transformative approach for document search, document data access, and presentation of documents and digital content associated with these documents. This approach involves the use of self-determinative documents that operate independently and as part of a document management hub to provide users with a truly customized and revolutionary way of searching for, editing, and monitoring various activities associated with electronic documents.

Self-determinative documents may be designed to maintain control over their lifecycle, access, and interactions, reducing the reliance on pseudo-control mechanisms such as policies, procedures, and legal agreements. By embedding intelligence directly within the document, the embodiments of this disclosure may provide a robust framework for ensuring security, integrity, and compliance, even when documents are shared externally or distributed across various platforms. This embedded intelligence also accesses data related to various parts of these documents to generate a visual layout presentation framework that significantly simplifies the process of identifying a document of interest, thereby resolving the traditional deficiencies relating to document searching.

Further, traditional methods of managing electronic documents often result in a loss of control once the document is shared, as highlighted in the example of a company granting an employee access to proprietary information. The systems and methods disclosed herein may address this problem by provisioning documents with embedded intelligence, such as an integrated API or software chip, which allows the document to autonomously enforce access permissions and track interactions. For instance, a self-determinative document containing sensitive company data can restrict access to authorized users only, even if the document is shared externally. If an employee leaves the company, the document can revoke their access in real-time, ensuring that proprietary information remains secure without requiring legal intervention.

In addition, self-determinative documents have one or more of a variety of attributes and advantages that enable them to address the drawbacks of traditional documents. These include dynamic access control, the ability to be a single source of truth, enhanced security and confidentiality, streamlined collaboration and compliance, universal accessibility, integrity and availability, true ownership, empowering ownership transitions, and enabling a universal frictionless system of record. The advantages of self-determinative documents are further improved when operating as part of and in collaboration with a document management hub. These include an improved visual layout frameworks for presenting document search results, advanced search result filtering, automatic and seamless content propagation, and efficient workflow management. These and other features and advantages enable a world that is transformed by self-determinative documents.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

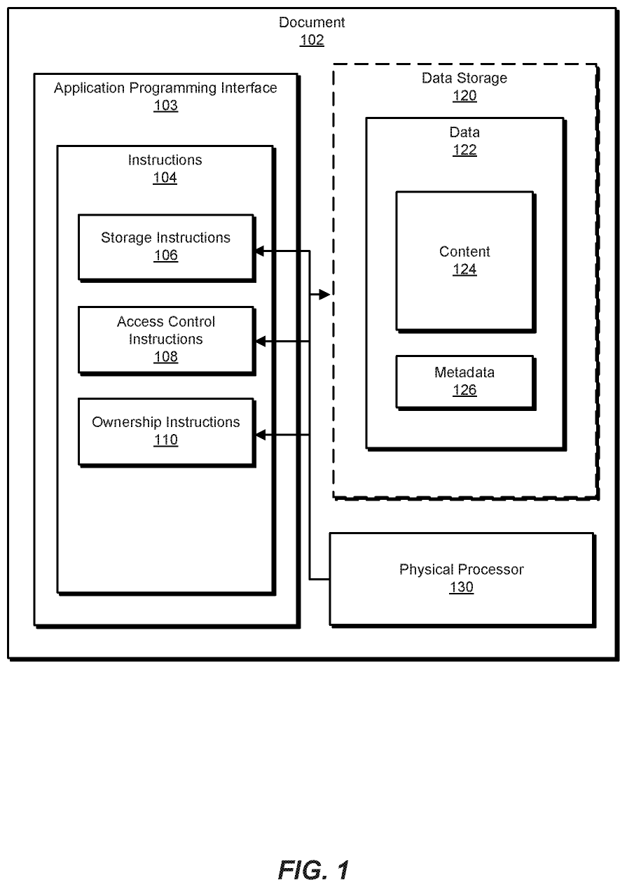

FIG. 1 depicts a structure of a self-determinative document. The self-determinative document 102 (interchangeably referenced in this disclosure as the electronic document 102 or the document 102) serves as a digital infrastructure that integrates various interfaces and components to manage various aspects of the document, e.g., access to the document, editing the document, sharing the document, and so forth. Provisioned as digital infrastructure, the document 102 includes an application programming interface (API) 103 with instructions 104. The instructions 104 play an important role in the operation of the electronic document 102, namely providing the necessary connections between the document 102 and its various functionalities. These instructions 104 include the storage instructions 106, access control instructions 108, and ownership instructions 110. Each instruction is responsible for a specific aspect of the document's functionality, ensuring that data is stored securely, access is controlled, ownership is maintained, and trust is established.

The storage instructions 104 are responsible for managing the storage of data within the document 102. The storage instructions 104 interact with the data storage 120 to ensure that data 122 is stored efficiently and securely. The storage instructions 104 facilitates the retrieval and updating of data 122, allowing the document 102 to maintain a single true copy and ensuring consistency across all accessed versions. These storage instructions 104 plays an important role in the document's ability to provide dynamic content rendering and real-time updates.

In some examples, the data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata may include timestamps for when the document was created, edited, shared, or signed. It can also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata may indicate that a document is an NDA (Non-Disclosure Agreement), a marketing presentation, or a financial report. It may also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

The physical processor 130 is a hardware component that executes the instructions 102 embedded within the document 100. The physical processor 130 enables the document 100 to perform functions such as detecting signing actions, recording signatures, and managing the lifecycle of the document. This integration of hardware and software allows the document 100 to operate independently, adapting to various user environments and workflows.

An electronic document with embedded computer-executable code, which is also referred to herein as a smart electronic document, generally refers to a type of electronic document embedded with intelligence that enables it to autonomously monitor, record, and manage events associated with its lifecycle, access, and interactions. Unlike traditional documents, which depend on external systems or manual input to track changes and interactions, smart electronic documents are designed to independently identify and log activities such as access attempts, modifications, and interactions with other documents or systems.

The embedded intelligence within a smart electronic document allows it to maintain a detailed audit trail, offering insights into who accessed the document, when it was accessed, and what actions were performed. This capability is invaluable for ensuring compliance with regulatory requirements and organizational policies, as it provides a reliable and tamper-proof record of all document-related activities.

Smart electronic documents also enhance security by dynamically managing access permissions through mechanisms such as role-based access control, encryption, and multi-factor authentication. These documents ensure that only authorized users can view or modify their content. By transforming documents into active entities capable of self-monitoring and self-regulation, organizations can significantly reduce the risk of unauthorized access and data breaches while streamlining document management processes and maintaining data integrity. A smart electronic document is composed of code (i.e., intelligence), content, and metadata, which together enable its autonomous functionalities.

The attributes of a smart electronic document are multifaceted and address one or more of the limitations of traditional document management systems. For example, a smart electronic document is uniquely addressable, meaning it has a permanent and immutable identifier that distinguishes it from all other documents. This identifier ensures that the document can be reliably accessed and referenced, regardless of its location. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another attribute of a smart electronic document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes.

The creation of new versions is governed by strict rules and cryptographic mechanisms to ensure authenticity and prevent unauthorized modifications. When a user or system initiates a change, the smart electronic document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a smart electronic document is a foundational characteristic that ensures the integrity, reliability, and trustworthiness of the document throughout its lifecycle. This immutability is achieved through a combination of technical mechanisms and design principles, which are explained below.

The “content” of a smart electronic document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a smart electronic document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the smart electronic document does not alter the original content. Instead, it creates a new version of the document with its own unique identifier and cryptographic hash. The original version remains intact and accessible, ensuring that the history of the document is preserved. Each version of the document is uniquely addressable and linked to the previous versions, creating a hierarchical structure that allows users to trace the evolution of the document. This approach ensures that the original content is never overwritten or lost.

In some embodiments, the smart electronic document may leverage distributed ledger technology to ensure immutability. The content and its associated hash can be recorded on a distributed ledger, where each entry is cryptographically secured and immutable. This approach provides an additional layer of protection, as the distributed ledger ensures that the content cannot be altered without consensus from the network.

The smart electronic document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The smart electronic document can provide transparency to users by enabling them to verify the authenticity and integrity of the content at any time. This transparency is achieved through audit trails and visual indicators, ensuring that users can trust the document's reliability and security.

The access control instructions 108 manage who can access the data within the document 102. These instructions determine whether an entity is allowed to access the document 102 and control access based on predefined rules and permissions. By ensuring that only authorized users can interact with the document 102, the access control instructions 108, when executed, provide a secure environment for document management. The access control instructions 108 are essential for the document's capability to enable secure sharing and collaboration among multiple users with varying access levels. Further these instructions, when executed, ensure that multiple authorized users may simultaneously access and revise one or more parts of the document 102 such that the revisions appear on respective users interfaces of various devices associated with these users.

The ownership instructions 108 are designed to maintain control over the document 102, even when shared with third parties. This interface enables the document's owner to manage ownership rights and control the distribution of the document 102. This feature is important for ensuring that the document's ownership is preserved and that the document 102 can be linked to a specific context in which the document 102 was shared. The ownership instructions 108 provides the document's owner with the ability to revoke access or grant temporary access as needed.

The data storage 120 serves as an important component of the document 102, offering a secure location for storing data 122. The data storage 120 operates in conjunction with the storage instructions 104 to ensure that data is stored in an efficient and secure manner. The design of the data storage 120 maintains a single true copy of the document 102, ensuring consistency across all accessed versions.

The data 122 stored within the data storage 120 represents the content of the document 102. The data 122 is managed by the storage instructions 106 and is subject to the access control instructions 108, and ownership instructions 110. The data 122 serves as a central component of the document's functionality, providing the information that users interact with and manage through the document's interfaces.

The physical processor 130 is responsible for executing the instructions necessary for the operation of the document 102. The physical processor 130 handles updates to the document 102 and ensures that the document's functionalities are carried out efficiently. The physical processor 130 works in conjunction with the application programming interface 103 to execute the document's operations and manage the interactions of the document 102 with users and external systems.

The application programming interface (API) 103 is a significant component of the document 102, providing a standardized interface for interaction between the document 102 and external systems or users. The API 103 enables a range of functionalities, including controlled access, modification, and management of the content of the document. It serves as a conduit for interaction, allowing the document 102 to integrate seamlessly with other software systems and support enhanced functionalities like automated workflows and data synchronization. The API 103 plays a crucial role in transforming the document 102 into an active, controllable entity that can interact with its environment in a secure and managed manner.

In the context of embodiments of this disclosure, the API embedded within the document serves as a pivotal component that transforms the document into a smart digital object. This API is not merely a set of protocols for building and interacting with software applications; it is an integral part of the document itself, enabling a wide array of functionalities that enhance the document's utility, security, and control.

The API provides a standardized interface that allows the document to interact seamlessly with external systems, applications, and users. This integration enables the document to function as part of a larger digital ecosystem, where it can communicate and exchange data with other software systems, such as cloud services, enterprise applications, and third-party tools. Through the API, the document's owner or controller can remotely manage the document's access and usage. This includes monitoring who accesses the document, tracking changes, and enforcing security protocols. The API allows for real-time updates and modifications, ensuring that the document remains current and relevant, regardless of its location or the number of copies in existence.

The API is equipped with robust security features, such as encryption and access control mechanisms, to protect the document from unauthorized access and tampering. It acts as a gatekeeper, ensuring that only authorized users can interact with the document. This level of security is essential for maintaining the integrity and confidentiality of the document's content. Additionally, the API enables dynamic content rendering, allowing the document to display the most current information and adapt its content based on user interactions or external data inputs. This capability is particularly useful for documents that require real-time updates, such as financial reports, legal documents, or collaborative projects.

By embedding the API within the document, embodiments of this disclosure support enhanced functionalities like automated workflows, data synchronization, and collaborative features. The API allows the document to function as an active, controllable entity that can interact with its environment in a secure and managed manner. Furthermore, the API ensures that the document is device and platform agnostic, meaning it can be accessed and interacted with from various types of devices and operating systems without compatibility issues. This flexibility helps ensure that the document can be used effectively in diverse digital environments.

In some aspects, the API serves as an immutable interface, providing a consistent and reliable framework for accessing and interacting with the document. This immutability ensures that the document's structure and access protocols remain stable over time, enhancing trust and reliability for users and applications interacting with the document. In summary, the API embedded within the document is a transformative component that elevates the document from a static file to a dynamic, interactive digital object. It provides the necessary infrastructure for secure, controlled, and flexible document management, addressing the challenges of traditional document handling and offering a comprehensive solution for modern digital environments.

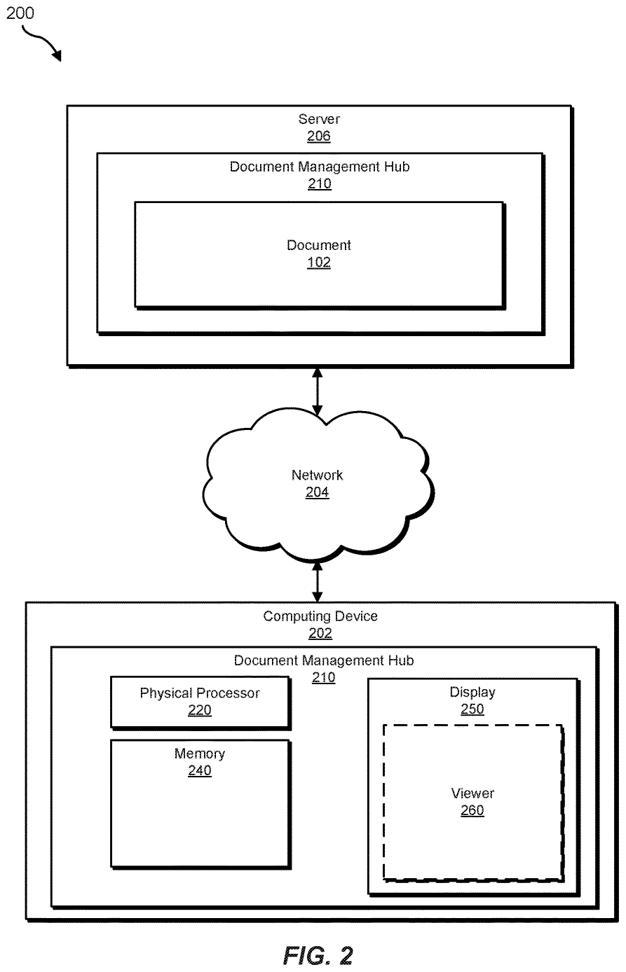

FIG. 2 illustrates a system 200 for managing electronic documents as smart digital objects. The system 200 comprises a computing device 202, a network 204, a server 206, a document 102, a document management hub 210 that can operate simultaneously in the server 206 and the computing device 202, a physical processor 220, a memory 240, and a viewer 260 that may be output on a display 250 communicatively coupled to the computing device 202.

The computing device 202 is a user-operated device that facilitates interaction with the system 200. The computing device 202 is operatively connected to the network 204 and includes the physical processor 220, the memory 240, and the viewer 260. The computing device 202 may be implemented as various types of devices, such as a mobile phone, tablet, desktop computing device, or laptop computing device. The physical processor 220 within the computing device 202 executes instructions to perform operations related to accessing and managing the document 102. The memory 240 stores data and instructions necessary for the operation of the computing device 202, including temporary and permanent storage of document-related information. The viewer 260 is responsible for rendering the content of the document 102 for presentation to the user, enabling functionalities such as real-time updates and collaborative editing.

The network 204 provides the communication pathway between the computing device 202 and the server 206. This pathway enables the transmission of requests, responses, and document content, while maintaining secure and efficient data exchange. The network 204 may be implemented using various communication technologies, including wired and wireless connections, and supports protocols such as TCP/IP and HTTP. The server 206 is a remote computing system that hosts the document 102. The server 206 is connected to the network 204 and interacts with the computing device 202 to process access requests and deliver the content of the document 102. The document 102 stored on the server 206 operates as a self-governing smart document capable of enforcing access permissions, tracking changes, and preserving the fidelity of the content within the document.

The document management hub 210 can comprise one or more machine readable instructions that are interconnected, interoperable, and capable of being executed simultaneously by the processors of multiple devices, e.g., the computing device 202 and the server 206. While all of the machine readable instructions that comprise the document management hub 210 may be executable on multiple devices, not all devices may have access to all of the instructions that comprise the document management hub 210. The document management hub 210 comprises a set of instructions that control the generation and display of various categories, virtual folders, and digital content instances linked to various electronic documents based on user specific queries and preferences. In some aspects, the document management hub 210 also controls integration of electronic documents provisioned as digital infrastructure with a plurality of third party proprietary software applications and platforms, as described later on in this disclosure.

The physical processor 220 within the computing device 202 executes operations related to the system 200, including processing access requests, rendering document content, and managing user interactions. This component facilitates the computing device 202 in performing tasks independently and with optimized performance. The memory 240 provides storage capabilities for the computing device 202, including the temporary caching of document data and the storage of instructions required for the operation of the viewer 260. This configuration enables the computing device 202 to access and manage the document 102 in an efficient manner.

The viewer 260 serves as the interface enabling the user to engage with the document 102. This component presents the content of the document 102 for display, facilitating actions such as viewing, editing, and collaboration. The viewer 260 accommodates real-time updates and maintains alignment between the displayed content and the version stored on the Server 206.

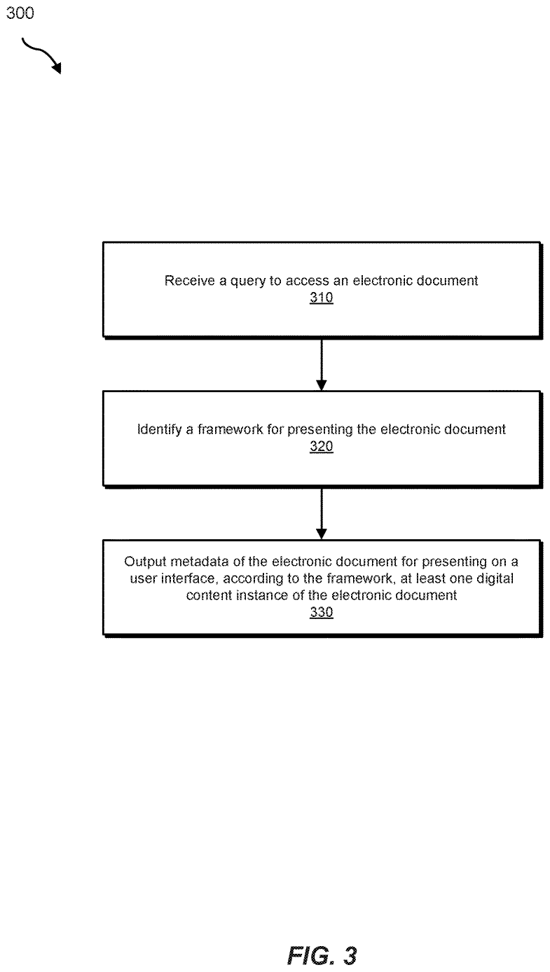

FIG. 3 illustrates a flowchart diagram of a method 300 for presenting digital content instances on a user interface in accordance with a framework. This flowchart enumerates the steps involved in presenting digital content representative of the electronic document 102 according to a particular framework. The flowchart begins with step 310, wherein the electronic document 102 receives a query. Then, at step 320, the document management hub 210 operating independently or in combination with the electronic document 102, identifies a framework for presenting the electronic document 102. Finally, step 330 involves outputting metadata of the electronic document 102 for presenting on a user interface, according to the framework, at least one digital content instance of the electronic document 102.

At the outset, it is instructive to briefly revisit the concept of the document 102 as described herein. The document 102 acts as or is provisioned as digital infrastructure that integrates various interfaces and components to manage and update several capabilities and functionalities of the document. Specifically, the document 102 operates as a smart digital object capable of interacting with and incorporating various aspects of other electronic documents, various types of digital content (e.g., embedded videos, images, etc.), and aspects of a filing framework specific to an entity, e.g., government, company, etc. In some aspects, the document 102 operates as digital infrastructure within the document management hub 210 and accesses, interacts with, and performs various actions using data and metadata included in other electronic documents. The document 102 performs these actions either independent or while operating in combination with the document management hub

The data enhances the functionality, accessibility, and/or security of the document 102. This data can be stored directly within the document as embedded metadata, semantic tags, or encrypted content. This data and/or metadata associated with an electronic document may be stored in a single device or multiple devices. Additionally or alternatively, data can be accessible by the document 102 through various sources, such as linked databases or cloud storage systems, etc. The document 102 can dynamically retrieve and update information in real-time from various sources, e.g., financial reports, investment prospectuses, stock prices or various user interactions. Moreover, electronic documents provisioned as digital infrastructure can implement a number of access restrictions on themselves according to the preferences of the document owners. These restrictions can be updated approximately in real time as per the preferences of the document owners.

Additionally, data can be associated with the document 102 in other suitable ways, such as through audit trails, access logs, or related documents stored in a centralized system (e.g., the document management hub 210), providing a comprehensive view of the document's history and interactions. In some aspects, the APIs included as part of these documents provides a comprehensive view of a document interaction history to the owners. Indeed, in some examples, the term “electronic document” refers to any data, metadata, audit information, or intelligence that pertain to the electronic document. In other words, an electronic document may be made up of its data, metadata, intelligence, and/or other information. The data, metadata, intelligence, and/or other information of a document may be stored in any suitable manner (e.g., each of these items may be stored in a single database or device, distributed across multiple database or devices, distributed across networked devices, etc.).

Data may be stored within or otherwise associated with an electronic document through execution of the electronic document on a computing device, a process that enables the document's function as a smart digital object. In some aspects, this process is not merely about saving data in a conventional sense but involves a sophisticated mechanism that ensures the document acts as a dynamic and interactive entity. As explained above, in some examples, the document is provisioned to maintain a single true copy, which facilitates ensuring consistency and integrity across all accessed versions. This single true copy can be stored in a secure environment, leveraging cloud-based infrastructure to facilitate accessibility and scalability.

Storing data within a document through execution of the document refers to the process where the document itself, as an active digital entity, manages and updates its own data content dynamically. This concept transforms the document from a static file into an interactive and intelligent object capable of executing operations to modify its content. In some examples this involves including executable code or an API as part of the document, which allows it to perform actions such as data retrieval, processing, and storage autonomously. For example, a document can be programmed to fetch the latest data from a remote server or database whenever it is opened, updating its content with real-time information such as current stock prices or weather forecasts. Another example is a collaborative document that tracks changes made by different users, storing these modifications within the document itself to maintain a comprehensive version history. This capability is particularly useful in environments where documents need to reflect the most current data or where user interactions need to be logged and managed directly within the document. By executing these operations internally, the document can ensure data consistency and integrity.

Returning to FIG. 3, step 310 involves receiving a query, at an electronic document provisioned as digital infrastructure, a query to access the electronic document. Various types of entities may initiate such queries, e.g., employees, contractors, or collaborators, who need to access the document for work-related purposes. They may request access to view, edit, or comment on the document based on their roles and permissions. Automated systems, such as software applications or services, may also require access to the document for processing or integration purposes. For example, a data analysis tool can request access to extract information from the document for reporting or analytics. External partners, including business partners, clients, or vendors, may need access to the document as part of a collaborative project or transaction, with limited or conditional access based on agreements or contracts.

Regulatory bodies, such as government agencies or compliance auditors, can request access to the document for verification or auditing purposes, typically governed by legal or regulatory requirements. Third-party applications that integrate with the document's API to provide additional functionality, such as document signing, workflow automation, or content management, may request access to perform specific tasks or operations. Additionally, cloud services that host or manage the document as part of a broader digital ecosystem may request access to synchronize data, perform backups, or facilitate collaboration across different users and devices. Each of these entities may have different levels of access and permissions, which are managed and controlled through the document's API to ensure security and compliance with organizational policies.

Additionally, the document's API can support role-based access control, allowing different levels of access based on the entity's permissions. This means that the document can provide personalized access experiences, where users with different roles or security clearances see only the parts of the document they are authorized to view. This capability is particularly important in environments where sensitive information must be protected from unauthorized access. The document can also maintain a real-time access control list, dynamically updated based on user activity and permissions. This list ensures that access decisions are made with the most current information, enhancing the document's security and control capabilities.

Returning to step 310, in some aspects, one of the entities described above (referred to herein as a user) enters a query to locate and gain access to an electronic document, e.g., the document 102. The query includes search terms entered into a character field presented on the viewer 260, which is output on a display communicatively coupled to the computer device 202. In some aspects, the search query can include one or more search terms in the form of, e.g., text, numbers, alphanumeric characters, images, other forms of digital content, or some combination thereof. In some aspects, the query can include a search term and a selection of a type of view preferred by a user (e.g., a table view or a folder view).

Step 320 involves the document management hub 210 identifying, using the query, a framework for presenting the electronic document. The document management hub 210 may perform this step as a result of executing one or more instructions and accessing data and metadata in the electronic document 102 as well as the data and metadata of other documents. The framework comprises a visual layout that includes at least one or more digital content instances representative of the document. For example, the framework may be a particular arrangement of multiple interactive category icons and plurality of virtual interactive folders output on the viewer 260, where a plurality of virtual interactive folders are nested within each corresponding distinct category interactive category icon. Each virtual folder may include digital content instances linked to respective electronic documents. The names and number of category icons and virtual interactive folders are tailored to and generated based on the query.

Step 330 involves the document management hub 210 outputting metadata of the electronic document for presenting on one or more user interfaces, according to the framework, at least one digital content instance of the electronic document. The digital content instance, as stated above, can comprise various types of interactive digital content instances that are linked with and enables access to a document of interest, e.g., the document 102. For example, the digital content instance may be a user selectable link associated with the document 102. When selected, the document management hub 210 facilitates display of the electronic document 102 associated with this link on the viewer 260.

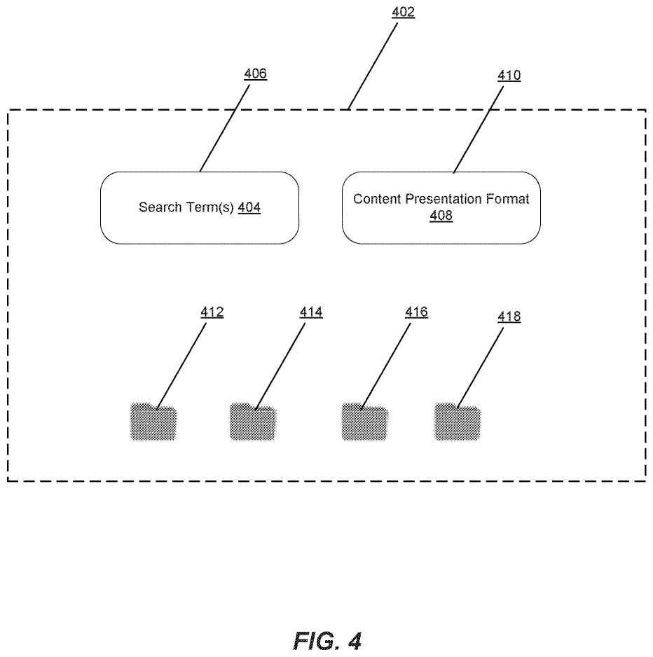

FIG. 4 illustrates an example digital home page 402 of the document management hub 210. The document management hub 210 may output this page on the viewer 260 of a user's device. In some aspects, a user may wish to access an electronic document but fail to remember the file name, precise location, and other pertinent details relating to the document. The user may, however, remember the year the document was created, the type of the document (invoice, memorandum of understanding, etc.), and the format of the document (word, pdf, etc.). The user may input some combination of this information (e.g., search terms 404) into a search field 406 displayed on the example digital home page. Additionally, the user may select a content presentation format 408 from, e.g., a table view or a folder view, from a dropdown menu 410. In some aspects, the example digital home page 402 includes a plurality of virtual folders represented by virtual folder icons 412, 414, 416, and 418. The document management hub 210 may identify virtual folders that a user has most recently accessed and present the virtual folder icons representative of these folders on the home page 402.

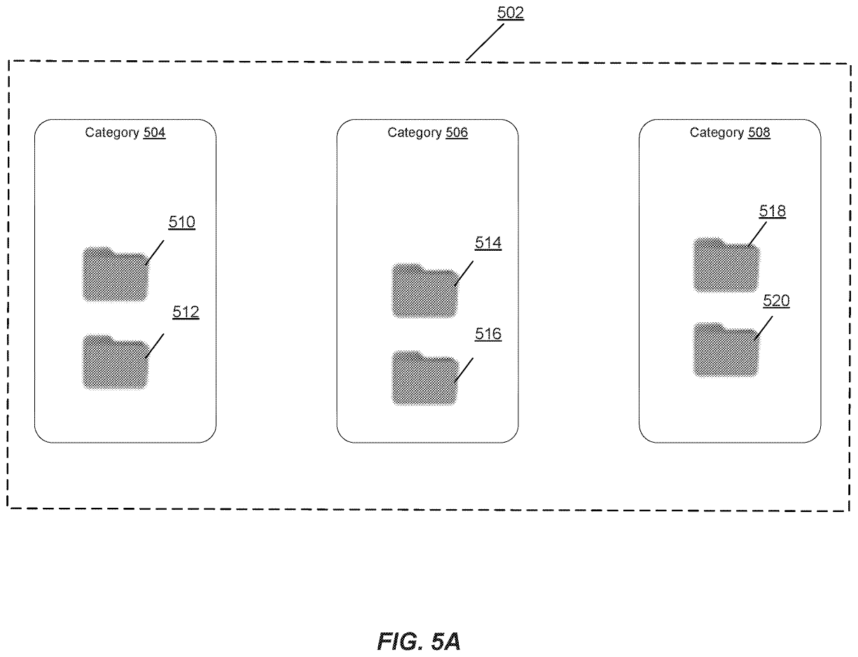

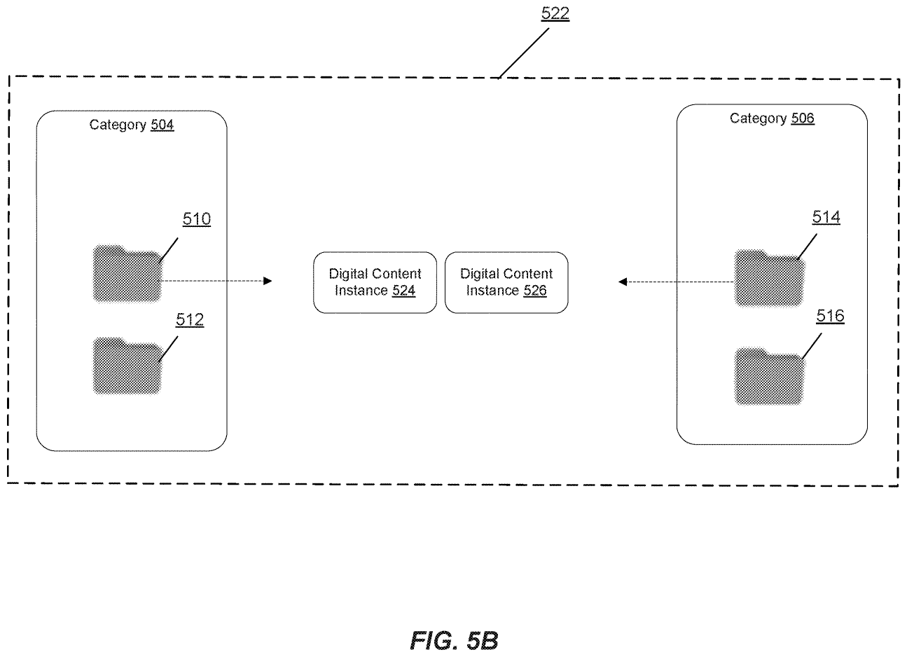

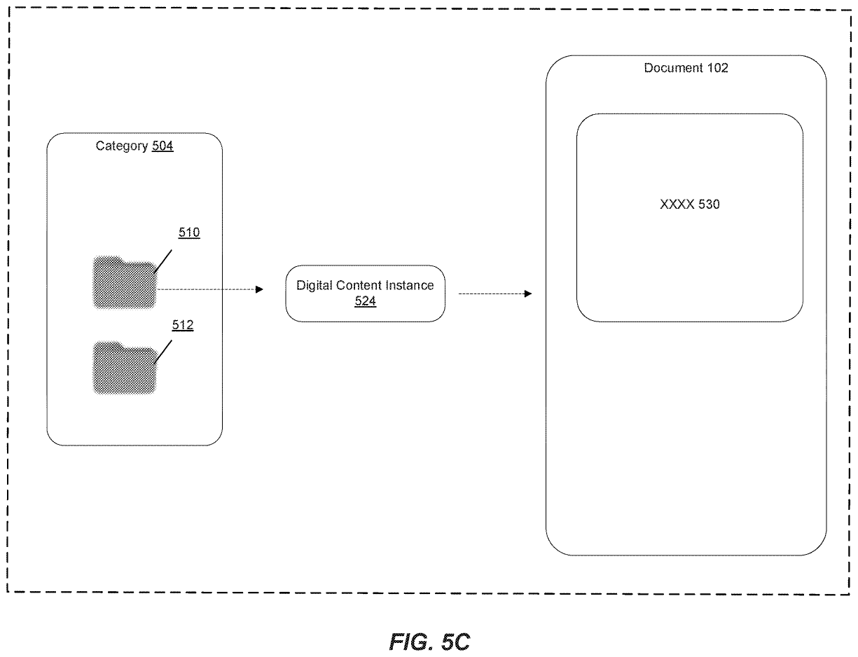

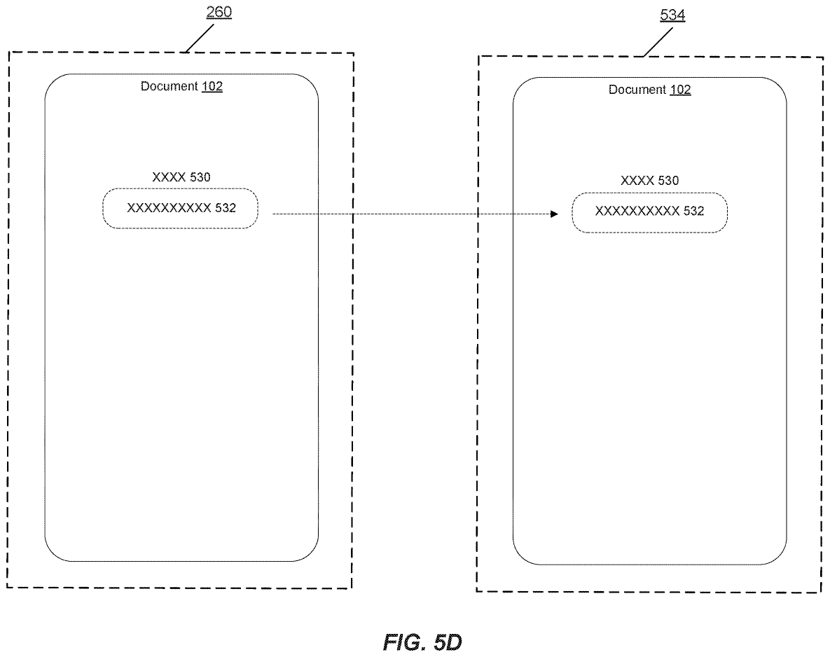

FIG. 5A illustrates an example search results page 502 displayed on the viewer 260, tailored to the users'search query. As shown, the document management hub 210, responsive to the query, generates three distinct interactive categories—504, 506, and 508—along with six virtual interactive folders—510, 512, 514, 516, 518, and 520 and outputs these categories and folders according to a framework (an arrangement) on the viewer 260 of the user's device. Specifically, the hub 210 arranges the virtual folders 510 and 512 within category 504, folders 514 and 516 within category 506, and folders 518 and 520 within category 508. The hub 210 then includes one or more digital content instances associated with an electronic document that the user desires to access within one or more of these virtual folders.

FIG. 5B illustrates an example digital content instances page 522 that includes multiple digital content instances associated with an electronic document that a user may desire to access. The user may not remember the virtual folder or folders in which he filed the electronic document, and as such, may select virtual folders 510 and 512 in category 504 and virtual folders 514 and 516 in category 506 to find the electronic document of interest. Upon user selection of these folders, the document management hub 210 presents the digital content instances included in these virtual folders, namely the digital content instances 524 and 526. Each digital content instance can be, e.g., a user selectable interactive link. When the user selects one or more of these instances, the document management hub 210 displays the electronic document 102—the original and only authoritative version of the document—on the viewer 260. Alternatively, the document management hub 210 presents the digital content instances 524 and 526 as digital interactive cover pages. Upon user selection of one of the cover pages, the document management hub 210 presents the original authoritative version of the document in redacted form. In other words, the hub 210 displays a partial version of the original authoritative document stored in, e.g., memory of the server 206, such that only the first few pages of the document 102 are visible to the user. In some aspects, an unredacted version of the electronic document 102—the original authoritative document—may also be presented on the viewer 260. While a user selectable interactive link and a cover page are described, the content instances may be associated with or represent various other types of interactive digital content.

FIG. 5C illustrates the document management hub 210 presenting the electronic document 102 on the viewer 260. After the user selects the digital content instance 524 (e.g., user selectable link), the hub 210 identifies the location of the authoritative version of the electronic document, executes one or more instructions stored in memory of the server 206, and presents the electronic document 102 on the viewer 260 for user interaction. The document 102 may include text 530 or content represented in various other forms, e.g., alphanumeric characters, images, embedded files such as video files, audio files, animations, and so forth.

As the electronic document 102 is provisioned as digital infrastructure (e.g., a smart document with executable instructions and an API), there is only one authoritative version of the electronic document 102 and it is this version that is accessed by all authorized users. While the document 102 may provide varying degrees of access to a subset of these authorized users, via execution of access control instructions 108 in the API of the document 102, all authorized users access, interact with, and modify the one authoritative version of the document 102. In stark contrast, conventionally, multiple versions of a particular document may be stored in different virtual locations with each version including content that is absent from other versions, causing significant frustration for users.

FIG. 5D illustrates a seamless and user friendly document editing process. The user may modify the electronic document 102 displayed on the viewer 260 by, e.g., adding additional text 532. The document 102, via execution of one or more instructions of the API embedded therein, may incorporate the additional text 532 approximately in real time (e.g., within a second or a few fractions of a second) such that the additional text 532 may appear on the document 102 that is being viewed by the owner of the document on, e.g., example display 534 communicatively coupled to the server 206. In this way, multiple users—the user viewing the document 102 on the viewer 260 and the owner viewing the document 102 on the example display 534 (e.g., communicatively coupled to the server 206)—may simultaneously view, revise, and interact with the document 102. In this way, the document 102, provisioned as digital infrastructure, enables seamless, efficient, and user friendly document editing.

The document 102 may be, e.g., a real estate lease agreement between two parties and the user may be a tenant that wants clarification on a clause that defines the tenant's responsibilities and/or obligations. The tenant may include the additional text 532 in the form of a question or comment requesting clarification on the meaning of the clause. Conventionally, the tenant's comment would remain on his or her version of the document, which would then have to be transmitted to the landlord (e.g., owner) for further changes. Here, however, all revisions are associated within and made on the electronic document 102 (the authoritative version).

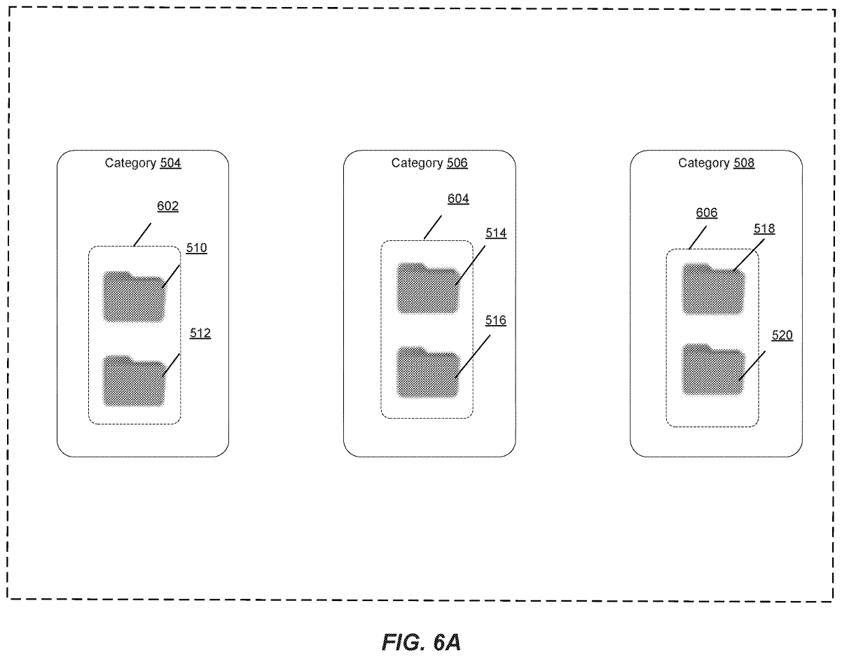

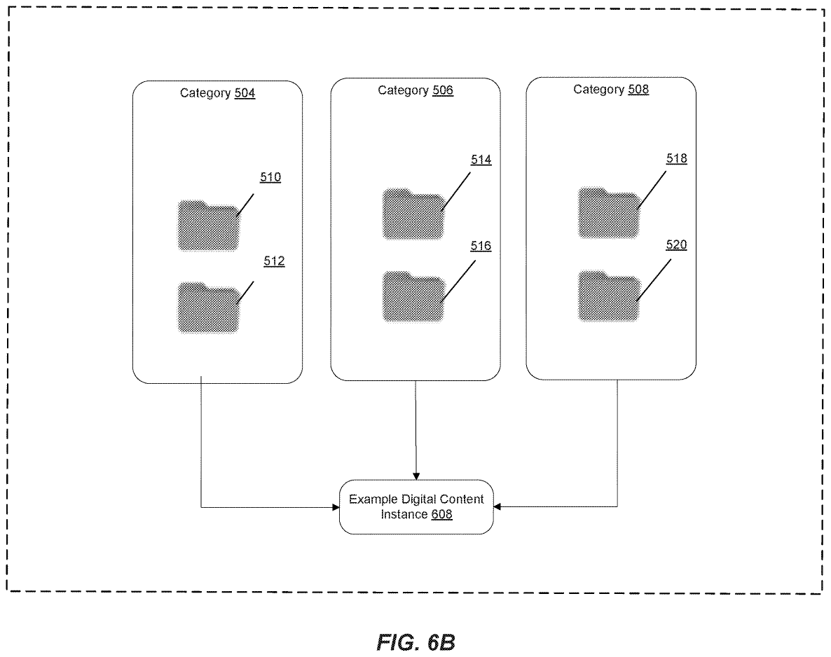

FIG. 6A illustrates an advanced search filtering operation implemented by the document management hub 210. A user may want to determine whether the electronic document 102 has been filed in multiple virtual folders filed in different categories. In some aspects, the document 102 may be filed in this manner if, e.g., it includes content that is relevant to all three categories. For example, the categories 504, 506, and 508 may correspond to a particular year, e.g., 2022, a “Product” category, and an “Invoice” category. If the user wants to find an invoice for a product purchased or sold in the year 2022, but cannot remember any additional details, he may select all the virtual folders (indicated by dotted lines 602, 604, and 606) to determine whether a digital content instance (or multiple digital content instances) is present in all selected virtual folders, e.g., virtual folders 510, 512, 514, 516, 518, and 520. In response, the document management hub 210 may analyze the contents of the selected virtual folders, automatically and without intervention and approximately in real time, and identify one or more digital content instances included in two or more of these folders. In other aspects, an additional query input field may appear upon selection of the virtual folders in which the user may or may not choose to input additional information.

FIG. 6B illustrates the document management hub 210 outputting an example document content instance 608 present in three virtual folders. Specifically, the document management hub 210 identifies an example digital content instance 608 as being present in three of the six virtual folders such as virtual folders 510, 514, and 518. The example digital content instance 608 may be linked to the electronic document 102 which may be, e.g., an invoice for a product that was purchased in the year 2022. As the product was purchased in 2022, and the evidence for the purchase is an invoice, the invoice was filed in virtual folders 510, 514, and 518 in categories 504 (e.g., year 2022), 506 (product), and 508 (document type), respectively. The user may interact with the example digital content instance 608 to access the subject matter of the electronic document of interest. For example, the user may select the digital content instance 608 and the document management hub 210 may present the invoice (the electronic document) on the viewer 260. Information regarding the invoice can be accessed in other ways as well, e.g., by hovering a cursor over the example digital content instance 608, in response to which a document preview image, a snippet, an animation can also be presented.

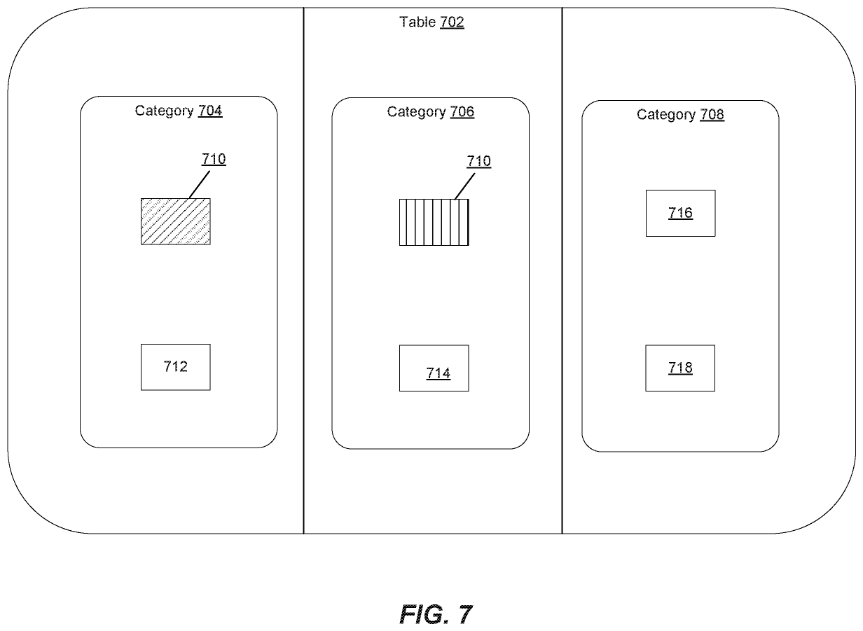

FIG. 7 illustrates the document management hub 210 presenting search results on the viewer 260 according to another framework. The hub 210 presents the search results as part of a table 702, which includes three different categories-categories 704, 706, and 708. Within each of the categories are multiple interactive icons-interactive icons 710, 712, 714, 716, and 718. Each interactive icon is linked to one or more electronic documents. The document management hub may include a particular interactive icon in two different categories and display each instance of the interactive icon with different characteristics. For example, the hub 210 may present interactive icon 710 with diagonal lines under category 704 and straight vertical lines in category 706. The diagonal lines may indicate a first pending action and the straight vertical lines may indicate a second pending action. These actions can correspond to pending tasks that need to be performed on an electronic document linked to the interactive icon 710. For example, the diagonal lines on the interactive icon 710 can indicate a need for a signature on a particular page of the electronic document linked to the icon and the vertical lines indicate a need for initials on the document. While diagonal and vertical lines are discussed, the interactive icon 710 can be depicted with a variety of other characteristics, e.g., colors, symbols, alphanumeric characters, and so forth, with each characteristic representing one or more pending tasks in need of completion.

In some aspects, the document management hub 210 can apply a particular framework specific to a particular user to another user or a plurality of other users. For example, a document owner may have, using the document management hub 210, created a number of categories with specific labels and included a number of virtual folders within each of these categories. The category labels and the labels of virtual folders within them help organize electronic documents efficiently, making it easier to access a specific document. A user may desire to replicate this owner's framework on his disorganized document filing structure.

For example, the user may instruct the document management hub 210, e.g., by selection of a user selectable icon, via inputting an inquiry, or other comparable ways, to apply the owner's framework to a list of his documents. In response, the document management hub 210 may access the owner's framework, analyze the relationship between each virtual folder and the category in which it is included, the characters of the labels of the categories and the virtual folders, access and analyze the user's documents, and generate, automatically and without user intervention, a framework recommendation for the user. Upon user approval, the document management hub 210 may implement the recommended framework onto the user's documents, automatically and approximately in real time.

In some aspects, the document management hub 210 may organize a user's documents according to the context in which these documents are accessed. For example, the document management hub 210 may determine that a user is accessing various documents at home, and as such, may categorize the user's environment as a home environment. Consequently, in some aspects, the document management hub 210 may present a home page that includes electronic documents with which a user frequently interacts. These documents may relate to the user's personal life and be presented on, e.g., the viewer 260, in a manner that makes these documents prominently visible to the user.

For example, these electronic documents may be a daycare schedule related to the user's child, a grocery list, a credit card bill that was recently accessed, and so forth. The document management hub 210 may display at least a subset of these documents in a particular order towards the left portion of the home page so that they are more likely to be noticed by the user. In this way, the document management hub 210 presents documents according to an environment in which the user accesses the document. The document management hub 210 may implement similar techniques to various other environments, e.g., work environment, community-service environment, and so forth.

The concept of a hub (document management hub 210) for smart documents introduces a transformative approach to document organization and interaction. Unlike traditional systems that rely on rigid folder structures or location-based organization, the hub creates categories and groupings that transcend physical or virtual locations. This capability allows any document to be connected to any other document, regardless of where they are stored or accessed. The intelligence embedded within the documents themselves plays a pivotal role in enabling this functionality. By leveraging metadata, audit trails, and contextual information, the hub dynamically identifies relationships between documents and organizes them into meaningful groupings. For example, consider a scenario involving an employer's medical check records. A co-owner of these records may need access to specific documents related to employee health benefits, compliance reports, and medical certifications. The hub's intelligence can seamlessly group these documents together, creating a unified experience that empowers the co-owner to access and manage the relevant information without navigating through disparate systems or locations. This superpower of the hub experience lies in its ability to transcend traditional boundaries, offering a fluid and intuitive way to interact with documents based on their relationships and context rather than their storage location.

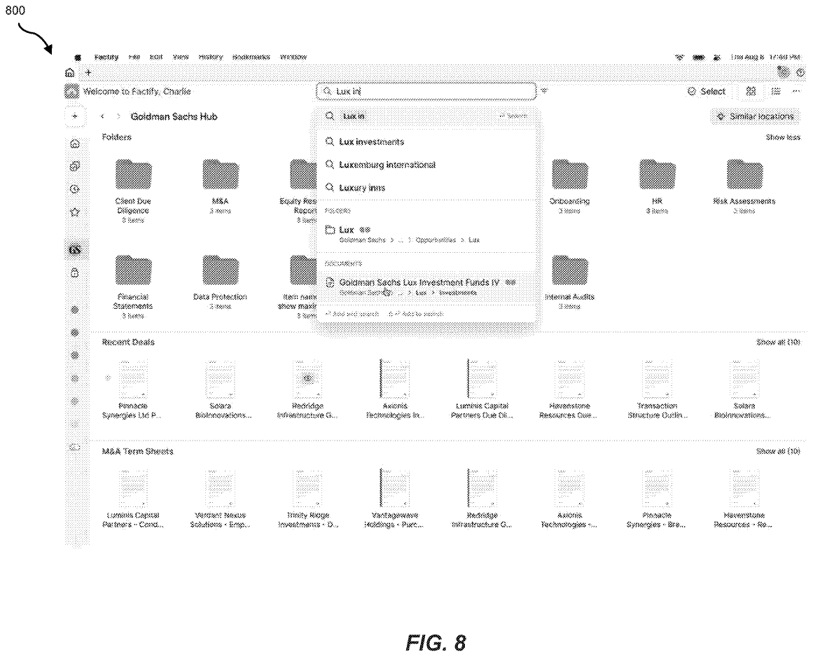

FIG. 8 illustrates an example visual layout 800 of a digital home page of the document management hub 210. The hub 210 may generate the example visual layout 800 such that it includes a virtual folders section and a recently accessed document section. The virtual folders section may include a number of virtual folders that a user has recently interacted with and the recently accessed document section may include a number of electronic document that the user has recently accessed, drafted, filed, etc. The hub 210 may also include a number of electronic document templates on the digital home page. These templates may correspond to documents that the user frequently opens in order to draft various agreements. This example visual layout 800 can vary based on the preferences of a particular user, a particular company, and so forth. Each of the items in the virtual folders may include digital content instances linked to various electronic documents, as described above.

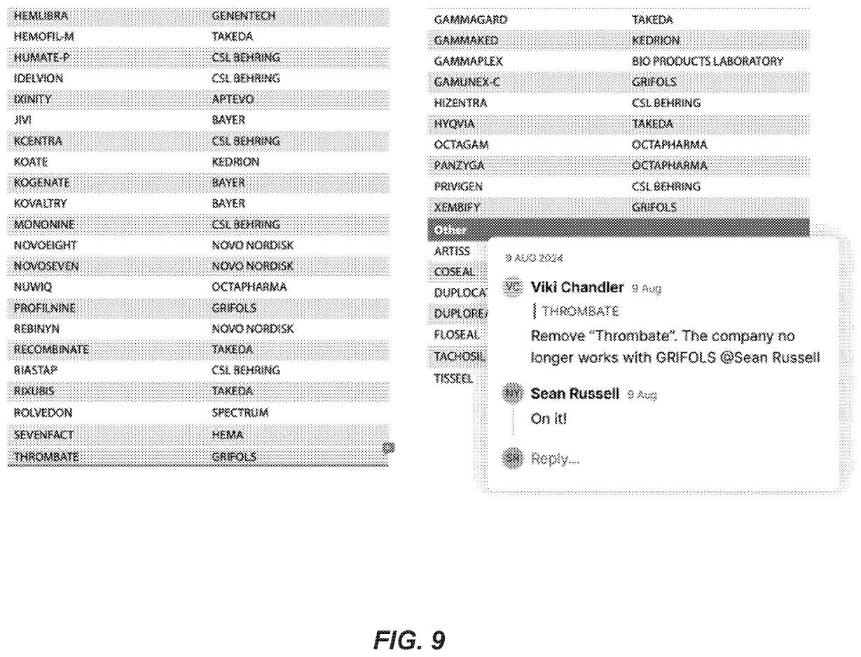

FIG. 9 depicts the simultaneous incorporation of multiple changes made to an electronic document provisioned as digital infrastructure. For example, a first user-Viki Chandler-may include a comment to remove a company from a company list included in an electronic document, e.g., the document 102. Viki may view the document 102 via a user interface that is output on a display coupled to her laptop. In response, another user-Sean Russell-may interact with the electronic document 102 output on his display (coupled to a different computing device) and add another comment acknowledging Viki's request. The comments of both Viki and Sean are incorporated into the document 102, via execution of one or more instructions included in the API of the document. Notably, both Viki and Sean modify the same document-the single authoritative version of the document 102.

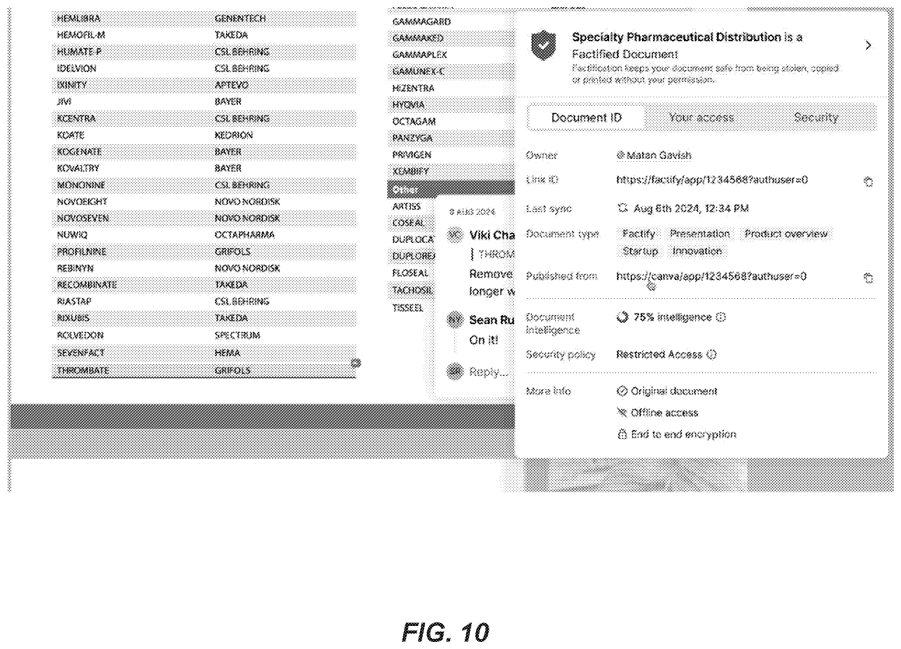

FIG. 10 illustrates a pop-up window that appears adjacent to the electronic document. For example, after comments from Viki and Sean are included, a third user (e.g., an owner of the electronic document 102) may include comments of his own. Thereafter, via execution of one or more instructions of the document's API, the comments of Viki, Sean, and the owner are incorporated into the document 102. In some aspects, if the owner chooses to restrict access to these changes, he may revise the security policy of the document 102 such that only a select group of individuals may view these changes. For example, the electronic document 102 may implement restrictions such that only a subset of users that have access to the electronic document 102 may be able to view the comments added by Viki and Sean. For example, the document 102, via execution of the access control instructions 108 and ownership instructions 110, may implement a complex tiered set of restrictions such that, users in a first tier may have access to all parts of the document, while users in a second tier may have access to, e.g., 50% of the document, while users in a third tier may only be able to access the first few pages. The document 102 may implement any permutation or combination of these restrictions.

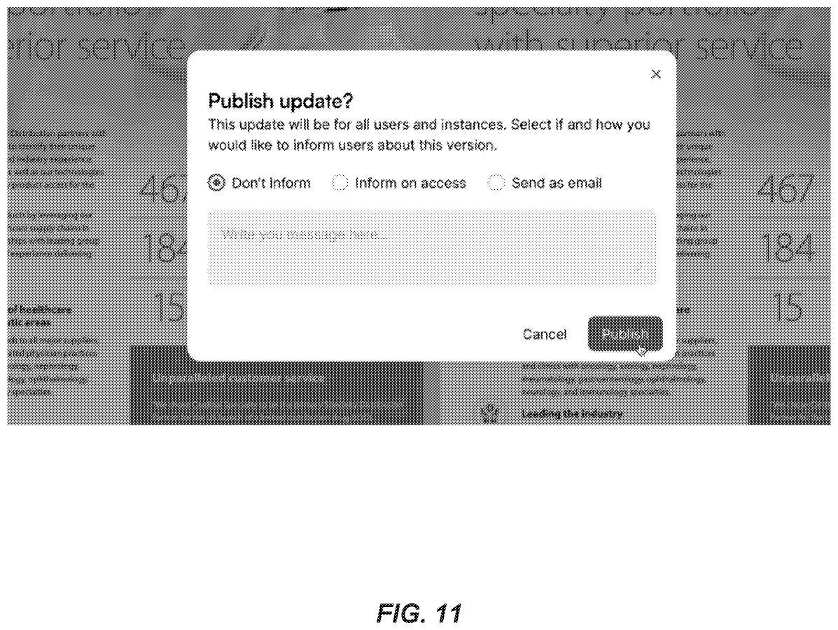

FIG. 11 illustrates how the electronic document 102 controls publication of changes. Here, publication can comprise some form of notification sent to various users that have access to the electronic document, e.g., a text message, an email, and so forth. As per the owner's preferences, the electronic document 102 may determine not to notify all authorized users about the changes made by Sean and Viki. For example, the changes made by Sean and Viki may be minor, irrelevant, or of relevance to only a select few users, and as such, the document 102 may determine that it is computationally efficient to notify only these select users of the changes. In some aspects, some changes made to the electronic document 102 may be very confidential in nature, and as such, as per the owner's preferences, the document 102 may decide to forego publication altogether, as depicted in FIG. 11.

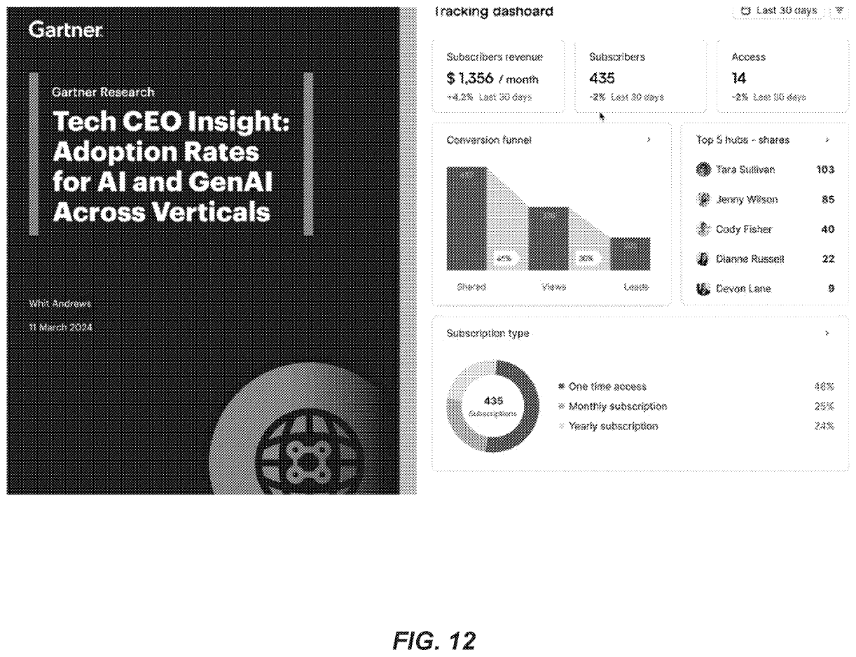

FIG. 12 depicts a customized dashboard that is specific to a particular electronic document and which may be accessible only to the owner of the document. As the electronic document is provisioned as digital infrastructure with an API, the document itself is capable of tracking a variety of different interactions associated with the document 102. As shown, the document 102, via execution of one or more instructions in the document's API, generates a dashboard that includes detailed information about the document 102, e.g., such as the number of subscribers (users) that have access to the document, the number of these subscribers that have viewed the document in the past 30 days, the amount of revenue generated as a result of subscribers accessing these documents, and so forth. Further, the document 102, via execution one or more instructions of the API, tracks the number of times various subscribers have shared it and ranks these subscribers accordingly. A number of other interactions may also be monitored.

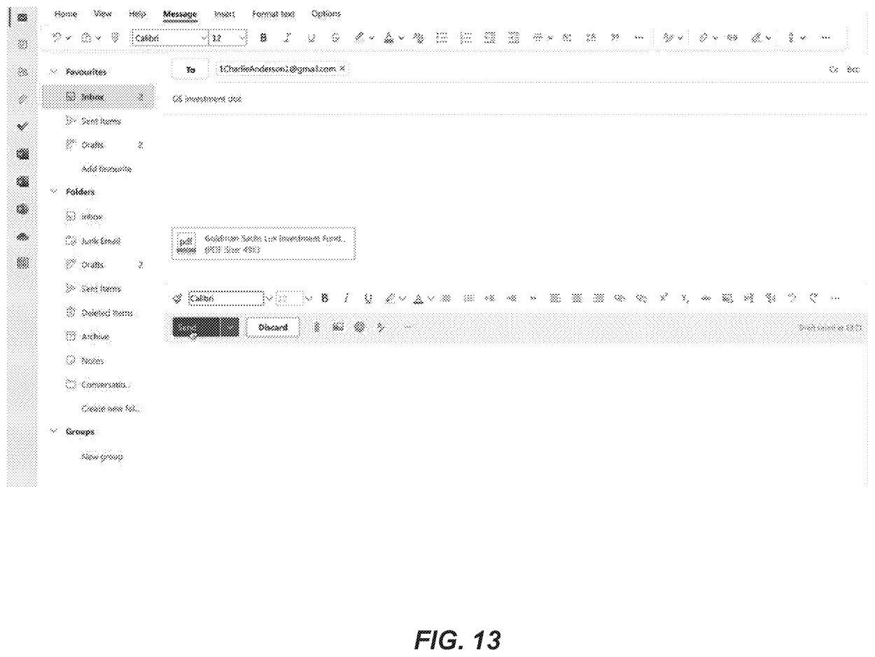

FIG. 13 illustrates the provisioning of an electronic document (e.g., a pdf document) as digital infrastructure at a particular stage of its use. In some aspects, a user may receive an electronic document that includes confidential information and share the document, either accidentally or deliberately, via a particular email channel to unauthorized users. As shown, a user may include the electronic document with confidential information as an attachment to an email and transmit it to a colleague. In such an instance, the document management hub 210 may determine whether the electronic document attached by the user has been provisioned as digital infrastructure or if its status as digital infrastructure has somehow been altered. If the hub 210 determines that the electronic document is no longer provisioned as digital infrastructure, e.g., due to document corruption or another comparable document related error, the hub 210 may, automatically and without user intervention, provision the attached electronic document as digital infrastructure.

Specifically, the hub 210 may provision the electronic document that was included as an email attachment as digital infrastructure before the document is received by the colleague. For example, upon selection of the “send” button by a user, the hub 210 may provision the document as digital infrastructure such that access to the electronic document is not the document 102. As such, the converted document is once again governed by preferences set by the document's owner. When the colleague receives the email from the user and attempts to open the attachment, he may only be able to view a redacted version of the document, e.g., a cover page in which only pages 1-3 of a 30 page document are visible.

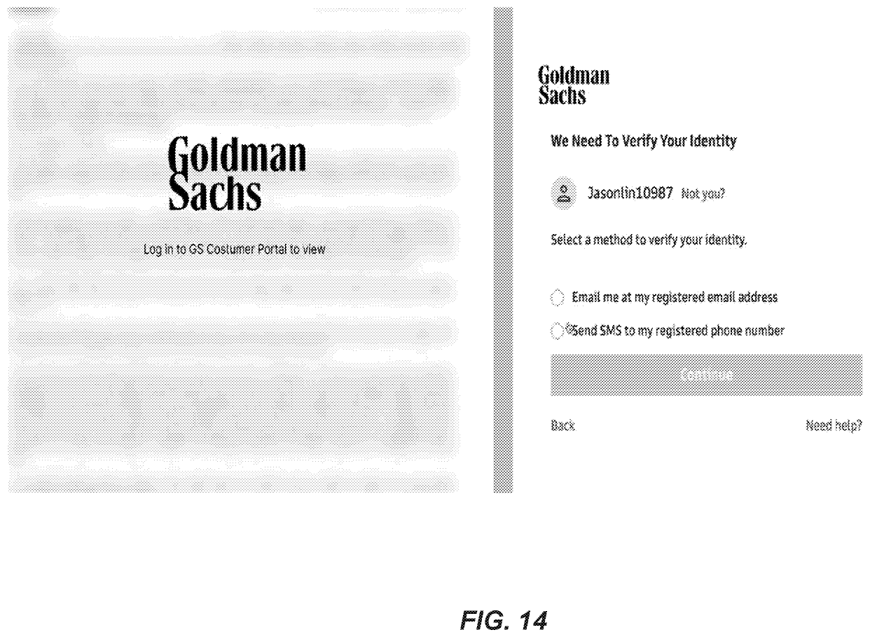

FIG. 14 illustrates an example software integration or collaboration between an electronic document provisioned as digital infrastructure and a software application or proprietary portal specific to a company. For example, if an owner of the document 102 wants to employ proprietary document security measures specific to his organization, the document 102 can, via execution of one or more instructions in the API, implement such security measures. For example, upon sharing the electronic document with an authorized user, the owner can require the authorized user to enter authenticating information prior to accessing the contents of the document. As shown in FIG. 14, the authenticating portal is proprietary to a particular company and may be distinct from the document management hub 210 and the API of the document 102. Notably, however, the document's API may integrate, utilize, or access aspects of the authenticating portal, e.g., the data or metadata proprietary to the company. When the proprietary data and/or metadata is executed, the hub 210 and/or the document 102 enables the company's authenticating portal to control access to the document 102. In this way, the document 102 can integrate and collaborate with other software programs and platforms to manage communication of and access to the document 102.

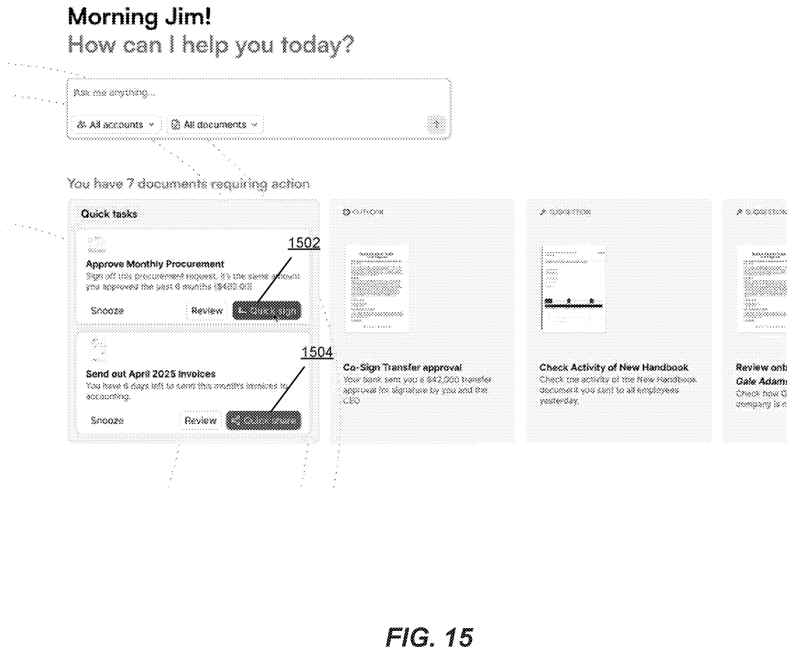

FIG. 15 illustrates another example visual layout of a home page of the document management hub 210. This layout is designed to improve workflow management in various ways. The document management hub 210 presents upcoming and urgent tasks specific to a user in a manner that enables the user to efficiently complete these tasks. For example, the hub 210 presents the two most urgent tasks, signing a monthly procurement document and sending invoices to various parties, on the left-most portion of the viewer 260 such that the user is likely to notice them first. Further, responsive to the user hovering a cursor over icons representative of these tasks, the hub 210 presents a Quick Sign 1502 and Quick Share 1504, e.g., interactive user selectable icons. Upon selection of the quick sign 1502, the document, via execution of one or more instructions in the API, include a signature on the document.

The user may not be required to open the electronic document, navigate to a page on which the signature is to be input, and input his signature. Instead, upon selection of the user selectable icon, the signature is included in the electronic document, automatically and approximately in real time. Similarly, the document management hub 210 may communicate multiple invoices to various parties upon the user selecting the Quick Share 1504 interactive user selectable link, thereby bypassing the need for the user to draft an email, attach each invoice, and send several emails to various parties. The built-in intelligence of the document management hub 210 tracks all parties that should receive these invoices, identifies these parties, and sends the invoices to these parties automatically, upon the user selecting the Quick Share 1504 interactive user selectable link.

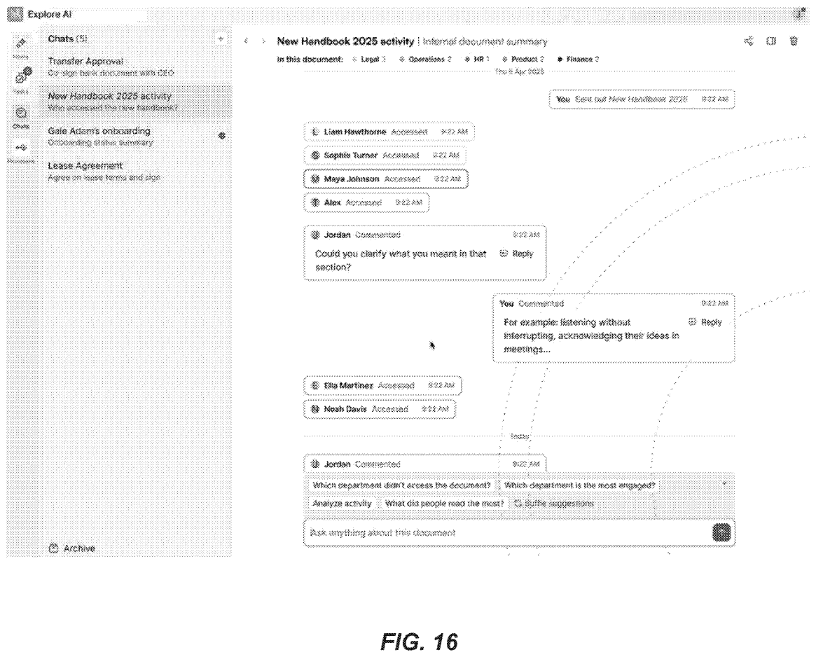

FIG. 16 illustrates the document management hub 210 outputting an example visual layout of a digital binder that includes a number of electronic documents provisioned as digital infrastructure. For example, the document management hub 210 may generate a grouping of multiple electronic documents provisioned as digital infrastructure and set document access restrictions specific to each of these documents. In aspects, the document management hub 210 may set document access restrictions to each of these documents by executing (1) the ownership instructions 110 and/or (2) one or more instructions stored in memory of the server 206, the memory 240, and/or in the memory of one or more additional devices.

In aspects, the document management hub 210 may generate a layout in which a page of one of the electronic documents is output on a left portion of a device's display and various details regarding at least one of the documents may be output on the right portion of the display. For example, on the hub 210 may include a name of the digital binder and three user selectable tabs titled “Document ID,” “Your access,” and “Validation” on the right portion of the display upon selection of “Validation.”

The concept of a hub for smart documents introduces a transformative approach to document organization and interaction. Unlike traditional systems that rely on rigid folder structures or location-based organization, the hub creates categories and groupings that transcend physical or virtual locations. This capability allows any document to be connected to any other document, regardless of where they are stored or accessed. The intelligence embedded within the documents themselves plays a pivotal role in enabling this functionality. By leveraging metadata, audit trails, and contextual information, the hub dynamically identifies relationships between documents and organizes them into meaningful groupings. For example, consider a scenario involving an employer's medical check records. A co-owner of these records might need access to specific documents related to employee health benefits, compliance reports, and medical certifications. The hub's intelligence can seamlessly group these documents together, creating a unified experience that empowers the co-owner to access and manage the relevant information without navigating through disparate systems or locations. This superpower of the hub experience lies in its ability to transcend traditional boundaries, offering a fluid and intuitive way to interact with documents based on their relationships and context rather than their storage location.

The user interface and API of smart documents redefine the way users and systems interact with digital records. The user interface is designed to be dynamic, responsive, and personalized, adapting to the needs of the user and the context of the document. For instance, the interface may present different panels or workflows depending on the user's role, the stage of the document's lifecycle, or the specific task being performed. This adaptability ensures that the user experience is intuitive and efficient, enabling seamless interaction with the document's content and metadata. At the same time, the API serves as the backbone of the document's intelligence, providing a standardized interface for external systems to interact with the document. The API enables the document to receive requests, process them, and return responses in a structured format, such as JSON or XML. This capability allows the document to integrate with other applications and systems, making it highly interoperable. For example, the API may facilitate real-time updates to the document's metadata based on user interactions or external data inputs, ensuring that the document remains current and relevant. Together, the user interface and API create a cohesive ecosystem that bridges the gap between human interaction and machine communication, transforming the document from a static file into a dynamic, interactive entity.

The paradigm of smart document management is fundamentally ad hoc, driven by the intelligence embedded within the documents and the queries made by users. Unlike traditional systems that require manual organization and retrieval, smart documents rely on AI-based management to dynamically adapt to the user's needs and context. The system of record is universal, meaning that users no longer have to worry about where they put their documents or how they are organized. The intelligence within the documents autonomously manages their lifecycle, interactions, and data flow, ensuring that information is always accessible and accurate.

For example, a user may query the system to find all documents related to a specific project, regardless of their storage location or format. The AI-based management system analyzes the query, identifies the relevant documents, and presents them in a coherent and intuitive manner. This automatic organization eliminates the need for manual intervention, streamlining workflows and reducing the risk of errors or inconsistencies. The universal system of record ensures that all interactions with the document are traceable and verifiable, providing a reliable source of truth for users and systems alike. This paradigm shift in document management transforms the way individuals and organizations interact with digital information, offering unparalleled efficiency, security, and adaptability.

AI-based management within a hub can revolutionize the way users interact with digital documents by dynamically adapting to their needs and preferences. For instance, the hub can analyze a user's search query and automatically categorize documents into relevant groups, such as contracts, invoices, or reports, based on semantic metadata. It can also prioritize search results by relevance, using machine learning algorithms to rank documents according to their historical usage patterns or contextual importance. For example, if a user frequently accesses financial reports during the end of the fiscal year, the hub can prioritize these documents in search results during that period. Additionally, the hub can present search results in a graphical interface that includes interactive icons, allowing users to quickly identify documents with pending tasks, such as signatures or approvals, by displaying visual markers like color-coded flags or symbols.

The hub can also generate personalized dashboards tailored to individual users, displaying frequently accessed documents, upcoming deadlines, and task reminders. For example, a project manager may see a dashboard highlighting overdue contracts and pending approvals, while a financial analyst may see a dashboard focused on quarterly reports and budget forecasts. Another function of the hub is its ability to provide advanced filtering options, enabling users to refine search results by criteria such as document type, creation date, or associated metadata. For instance, a user searching for a specific invoice can filter results to show only invoices created within the last month and associated with a particular client.

AI-driven predictive capabilities further enhance the hub's functionality. For example, the hub can analyze user behavior and suggest related documents that may be relevant to the current task, such as recommending a non-disclosure agreement when accessing a draft contract. It can also identify anomalies in document interactions, such as repeated failed access attempts, and alert users to potential security risks. The hub's graphical interface can adapt dynamically based on the device being used, ensuring an optimized experience whether accessed on a desktop, tablet, or mobile phone. For instance, the interface may display a simplified layout with touch-friendly navigation on a mobile device, while providing a more detailed view with advanced filtering options on a desktop.

The hub can also facilitate real-time collaboration by allowing multiple users to interact with the same document simultaneously. For example, during a team meeting, stakeholders can add comments, suggest edits, and track changes in real time, with the hub ensuring that all interactions are logged and synchronized across devices. Additionally, the hub can integrate with third-party applications, such as e-signature platforms or project management tools, to streamline workflows. For instance, a user can sign a document directly within the hub and have the signed version automatically sent to a project management system for tracking.

Another example of AI-based management is the hub's ability to provide contextual insights based on the document's lifecycle. For instance, if a document is in the approval stage, the hub can display a panel showing the list of approvers and their respective statuses, while hiding irrelevant options like analytics or distribution tools. Finally, the hub can generate visual summaries of document interactions, such as timelines showing when the document was accessed, edited, or shared, providing users with a comprehensive overview of its history. These examples illustrate the transformative potential of AI-driven hubs in modern document management systems.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker is established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:
Unchangeable: Immutable refers to something that cannot be altered, modified, or edited once it has been created or finalized.
Permanent: Immutable signifies a state of permanence, where the object or data remains fixed and consistent over time.
Irreversible: Immutable describes a condition where changes are impossible, and any attempt to alter the object or data is invalid or rejected.
Fixed: Immutable means that the structure, content, or state of an object is locked and cannot be adjusted or updated.
Tamper-Proof: Immutable implies that the object or data is resistant to tampering, ensuring its integrity and authenticity.
Finalized: Immutable refers to an object or data that has reached its final form and cannot be reverted or reshaped.
Unmodifiable: Immutable describes a characteristic where the object or data is impervious to modification, whether intentional or accidental.
Consistent: Immutable ensures that the object or data remains consistent and reliable, unaffected by external influences or changes.
Secure: Immutable denotes a state of security where the object or data is safeguarded against unauthorized alterations or corruption.
Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

### Negotiation of Communication Protocols: Smart

documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document can identify patterns in user interactions and recommend next steps, such as suggesting additional documents that may be relevant to the current task or flagging anomalies in the audit trail for review.

### How Intelligence Is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike Traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability Simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: the Permanent Global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has transformative implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In some examples, a smart electronic document may include three elements, at minimum—data (e.g., content, audit trail, other metadata, etc.), executable code (e.g., an API), and a globally unique marker.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

The following clauses show how aspects of this disclosure are technical solutions to technical problems and/or improve the functioning of a computing device.
Clause 1. A computer-implemented method, the computer-implemented method comprising: receiving, at an electronic document provisioned as digital infrastructure, a query to access the electronic document; identifying, using the query, a framework for presenting the electronic document; and outputting metadata of the electronic document for presenting on a user interface, according to the framework, at least one digital content instance of the electronic document.
Clause 2. The computer-implemented method of clause 2, wherein the query includes at least a search term related to the electronic document and a content presentation format.
Clause 3. The computer-implemented method of clause 2, wherein the content presentation format comprises a folder view or a table view.
Clause 4. The computer-implemented method of clause 3, wherein the identifying of the framework for presenting the electronic document comprises: generating the at least one digital content instance of the electronic document, wherein the at least one digital content instance comprises a user-selectable digital link associated with the electronic document.
Clause 5. The computer-implemented method of clause 1, wherein the at least one digital content instance is a user-selectable digital link associated with the electronic document.
Clause 6. The computer-implemented method of clause 1, wherein the at least one digital content instance is a digital cover-page associated with the electronic document.
Clause 7. The computer-implemented method of clause 3, wherein the receiving of the query to access the electronic document comprises: receiving, at the electronic document, the content presentation format and search terms related to the electronic document, the content presentation format being the folder view.
Clause 8. The computer-implemented method of clause 7, wherein the identifying of the framework for presenting the electronic document comprises: generating, by a document management hub, a visual layout including a plurality of interactive categories and a plurality of interactive virtual folders; and arranging, by the document management hub, a first subset of the plurality of interactive virtual folders in relation to a first interactive category of the plurality of interactive categories and a second subset of the plurality of interactive virtual folders in relation to a second interactive category of the plurality of categories.
Clause 9. The computer-implemented method of clause 8, wherein the first subset is different from the second subset.
Clause 10. The computer-implemented method of clause 8, wherein the arranging of the first subset in relation to the first interactive category and the second subset in relation to the second interactive category is responsive to the query.
Clause 11. The computer-implemented method of clause 8, wherein the generating of the framework for presenting the electronic document further comprises: including in one of the plurality of interactive virtual folders, by the document management hub, a user-selectable link associated with the electronic document; and including in an additional one of the plurality of interactive virtual folders, by the document management hub, a user-selectable cover page associated with the electronic document.
Clause 12. The computer-implemented method of clause 11, wherein the outputting of the metadata of the electronic document for presenting on the user interface comprises: presenting on the user interface, responsive to the document management hub executing one or more instructions and accessing the metadata, a user-selectable link associated with the electronic document being included in the one of the plurality of interactive virtual folders; and presenting on the user interface, responsive to the document management hub executing the one or more instructions and accessing the metadata, a user-selectable cover page associated with the electronic document as being included in the additional one of the plurality of interactive virtual folders.
Clause 13. The computer-implemented method of clause 8, further comprising: receiving, by the document management hub, selections of multiple virtual folders from the plurality of virtual folders; and receiving, by the document management hub, an additional query to determine whether the at least one digital content instance associated with the electronic document is in each of the multiple virtual folders that are selected.
Clause 14. The computer-implemented method of clause 13, wherein the outputting of the metadata of the electronic document for presenting on the user interface comprises: presenting on the user interface, responsive to the document management hub executing one or more instructions and accessing the metadata, the at least one digital content instance associated with the electronic document that is in each of the multiple virtual folders that are selected.
Clause 15. The computer-implemented method of clause 8, further comprising modifying content of the electronic document.
Clause 16. The computer-implemented method of clause 15, further comprising: presenting on the user interface of a first device responsive to the modifying, by the document management hub, the electronic document as including the content that is modified; and presenting on an additional user interface of a second device responsive to the modifying, by the document management hub, the electronic document as including the content that is modified.
Clause 17. The computer-implemented method of clause 1, further comprising: receiving, at the electronic document, a request for including the electronic document as part of a document organizational structure specific to an additional electronic document; and organizing by a document management hub, automatically and without user-intervention, the electronic document according to the document organizational structure specific to the additional electronic document.
Clause 18. The computer-implemented method of clause 1, further comprising: detecting, by a document management hub, a context associated with the electronic document; and organizing by the document management hub, automatically and without user intervention, the electronic document as part of a context-specific organizational structure based on the context associated with the electronic document.
Clause 19. The computer-implemented method of clause 18, wherein the context corresponds to an employer-environment, a school-environment, or a home environment.
Clause 20. The computer-implemented method of clause 19, wherein the context-specific organizational structure corresponds to a home-specific digital filing structure.
Clause 21. The computer-implemented method of clause 2, wherein the receiving of the query to access the electronic document comprises: receiving, at the electronic document, the content presentation format and a search term related to the electronic document, the content presentation format being a table view.
Clause 22. The computer-implemented method of clause 21, wherein the generating of the framework for presenting the electronic document comprising: generating, by a document management hub, a visual layout including a plurality of interactive categories and a plurality of interactive icons; and arranging, by the document management hub, a first subset of the plurality of interactive icons in relation to a first interactive category of the plurality of interactive categories and a second subset of the plurality of interactive icons in relation to a second interactive category of the plurality of categories, wherein the first subset is different from the second subset.
Clause 23. The computer-implemented method of clause 22, further comprising: associating, by the document management hub, at least one interactive icon in the first subset and at least one additional interactive icon in the second subset with the electronic document.
Clause 24. The computer-implemented method of clause 23, wherein: the at least one interactive icon in the first subset of the plurality of interactive icons corresponds to a first pending action specific to the electronic document; and the at least one additional interactive icon in the second subset of the plurality of interactive icons corresponds to a second pending action specific to the electronic document.
Clause 25. The computer-implemented method of clause 24, wherein the first pending action corresponds to an in-document application and the second pending action corresponds to document circulation.
Clause 26. The computer-implemented method of clause 24, wherein the first pending action corresponds to obtaining a signature on the electronic document and the second pending action corresponds to obtaining initials on the electronic document.
Clause 27. A system comprising: a document management hub including at least one physical processor and physical memory comprising computer-executable instructions that, when executed by the at least one physical processor, cause the physical processor to: receive, at an electronic document, a query to access the electronic document; generate, using the query, a framework for presenting the electronic document; and output metadata of the electronic document for presenting on a user interface, according to the framework, at least one digital content instance of the electronic document.
Clause 28. The system of clause 27, wherein the query includes at least a search term related to the electronic document and a content presentation format.
Clause 29. The system of clause 28, wherein the content presentation format is a folder view or a table view.
Clause 30. The system of clause 29, wherein the computer-executable instructions, when executed by the physical processor, cause the physical processor to generate the framework for presenting the electronic document comprising: generating the at least one digital content instance of the electronic document, wherein the at least one digital content instance is a user-selectable digital link associated with the electronic document.
Clause 31. The system of clause 27, wherein the at least one digital content instance is a user-selectable digital link associated with the electronic document.
Clause 32. The system of clause 27, wherein the at least one digital content instance is a digital cover-page associated with the electronic document.
Clause 33. The system of clause 29, wherein the computer-executable instructions, when executed by the physical processor, cause the physical processor to receive the query to access the electronic document comprising: receiving, at the electronic document, the content presentation format and search terms related to the electronic document, the content presentation format being the folder view.
Clause 34. The system of clause 33, wherein the computer-executable instructions, when executed by the physical processor, cause the physical processor to generate the framework for presenting the electronic document comprising: generating a visual layout including a plurality of interactive categories and a plurality of interactive virtual folders; and arranging a first subset of the plurality of interactive virtual folders in relation to a first interactive category of the plurality of interactive categories and a second subset of the plurality of interactive virtual folders in relation to a second interactive category of the plurality of categories.
Clause 35. The system of clause 34, wherein the first subset is different from the second subset.
Clause 36. The system of clause 34, wherein the arranging of the first subset in relation to the first interactive category and the second subset in relation to the second interactive category is responsive to the query.
Clause 37. The system of clause 34, when executed by the physical processor, cause the physical processor to generate the framework for presenting the electronic document comprising: including, in one of the plurality of interactive virtual folders, a user-selectable link associated with the electronic document; and including, in an additional one of the plurality of interactive virtual folders, a user-selectable cover page associated with the electronic document.
Clause 38. The system of clause 37, when executed by the physical processor, cause the physical processor to output the metadata of the electronic document for presenting on the user interface comprising: presenting on the user interface a user-selectable link associated with the electronic document being included in the one of the plurality of interactive virtual folders; and presenting on the user interface a user-selectable cover page associated with the electronic document as being included in the additional one of the plurality of interactive virtual folders.
Clause 39. The system of clause 37, wherein the computer-executable instructions, when executed by the physical processor, further cause the physical processor to: receiving selections of multiple virtual folders from the plurality of virtual folders; and receiving an additional query to determine whether the at least one digital content instance associated with the electronic document is in each of the multiple virtual folders that are selected.
Clause 40. The system of clause 39, when executed by the physical processor, cause the physical processor to output the metadata of the electronic document for presenting on the user interface comprising: presenting, on the user interface, the at least one digital content instance associated with the electronic document that is in each of the multiple virtual folders that are selected.
Clause 41. The system of clause 34, wherein the computer-executable instructions, when executed by the physical processor, further cause the physical processor to modify content of the electronic document.
Clause 42. The system of clause 41, wherein the computer-executable instructions, when executed by the physical processor, further cause the physical processor to: presenting on the user interface of a first device, responsive to the modifying, the electronic document as including the content that is modified; and presenting on an additional user interface of a second device, responsive to the modifying, the electronic document as including the content that is modified.
Clause 43. The system of clause 27, wherein the computer-executable instructions, when executed by the physical processor, further cause the physical processor to: receiving a request for including the electronic document as part of a document organizational structure specific to an additional electronic document; and organizing, automatically and without user-intervention, the electronic document according to the document organizational structure specific to the additional electronic document.
Clause 44. The system of clause 27, wherein the computer-executable instructions, when executed by the physical processor, further cause the physical processor to: detect a context associated with the electronic document; and organize, automatically and without user intervention, the electronic document as part of a context-specific organizational structure based on the context associated with the electronic document.
Clause 45. The system of clause 44, wherein the context corresponds to an employer-environment, a school-environment, or a home environment.
Clause 46. The system of clause 45, wherein the context-specific organizational structure corresponds to a home-specific digital filing structure.
Clause 47. The system of clause 28, wherein the computer-executable instructions, when executed by the physical processor, cause the physical processor to receive the query to access the electronic document comprising: receive the content presentation format and a search term related to the electronic document, the content presentation format being a table view.
Clause 48. The system of clause 47, when executed by the physical processor, cause the physical processor to generate the framework for presenting the electronic document comprising: generate a visual layout including a plurality of interactive categories and a plurality of interactive icons; and arrange a first subset of the plurality of interactive icons in relation to a first interactive category of the plurality of interactive categories and a second subset of the plurality of interactive icons in relation to a second interactive category of the plurality of categories, wherein the first subset is different from the second subset.
Clause 49. The system of clause 48, wherein the computer-executable instructions, when executed by the physical processor, further cause the physical processor to: associating at least one interactive icon in the first subset and at least one additional interactive icon in the second subset with the electronic document.
Clause 50. The system of clause 49, wherein: the at least one interactive icon in the first subset of the plurality of interactive icons corresponds to a first pending action specific to the electronic document; and the at least one additional interactive icon in the second subset of the plurality of interactive icons corresponds to a second pending action specific to the electronic document.
Clause 51. The system of clause 50, wherein the first pending action corresponds to an In-Document Application and the second pending action corresponds to document circulation.
Clause 52. The system of clause 50, wherein the first pending action corresponds to obtaining a signature on the electronic document and the second pending action corresponds to obtaining initials on the electronic document.
Clause 53. A non-transitory computer-readable medium comprising computer-executable instructions that, when executed by at least one of one or more processors of a computing device, cause the computing device to: receive a query to access an electronic document; generate, using the query, a framework for presenting the electronic document; and output metadata of the electronic document for presenting on a user interface, according to the framework, at least one digital content instance of the electronic document.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

What is claimed is:

1. A computer-implemented method, the computer-implemented method comprising:
receiving, at an electronic document provisioned as digital infrastructure that maintains a single authoritative version of the electronic document, a query to access the electronic document;
identifying, using the query, a framework for presenting the electronic document; and
outputting metadata of the electronic document for presenting on a user interface, according to the framework, at least one digital content instance of the electronic document.

2. The computer-implemented method of claim 1, wherein the query includes at
least a search term related to the electronic document and a content presentation format.

3. The computer-implemented method of claim 2, wherein the content
presentation format comprises a folder view or a table view.

4. The computer-implemented method of claim 3, wherein the identifying of the framework for presenting the electronic document comprises:
generating the at least one digital content instance of the electronic document, wherein the at least one digital content instance comprises a user-selectable digital link associated with the electronic document.

5. The computer-implemented method of claim 1, wherein the at
least one
digital content instance is a user-selectable digital link associated with the electronic document.

6. The computer-implemented method of claim 1, wherein the at
least one digital content instance is a digital cover-page associated with the electronic document.

7. The computer-implemented method of claim 3, wherein the receiving of the query to access the electronic document comprises:
receiving, at the electronic document, the content presentation format and search terms related to the electronic document, the content presentation format being the folder view.

8. The computer-implemented method of claim 7, wherein the identifying of
the framework for presenting the electronic document comprises:
generating, by a document management hub, a visual layout including a plurality of interactive categories and a plurality of interactive virtual folders; and
arranging, by the document management hub, a first subset of the plurality of
interactive virtual folders in relation to a first interactive category of the plurality of interactive categories and a second subset of the plurality of interactive virtual folders in relation to a second interactive category of the plurality of categories.

9. The computer-implemented method of claim 8, wherein the first subset is
different from the second subset.

10. The computer-implemented method of claim 8, wherein the arranging of the first subset in relation to the first interactive category and the second subset in relation to the second interactive category is responsive to the query.

11. The computer-implemented method of claim 8, wherein the generating of the framework for presenting the electronic document further comprises:
including in one of the plurality of interactive virtual folders, by the document management hub, a user-selectable link associated with the electronic document; and
including in an additional one of the plurality of interactive virtual folders, by the document management hub, a user-selectable cover page associated with the electronic document.

12. The computer-implemented method of claim 11, wherein the outputting of the metadata of the electronic document for presenting on the user interface comprises:
presenting on the user interface, responsive to the document management hub executing one or more instructions and accessing the metadata, a user-selectable link associated with the electronic document being included in the one of the plurality of interactive virtual folders; and
presenting on the user interface, responsive to the document management hub executing the one or more instructions and accessing the metadata, a user-selectable cover page associated with the electronic document as being included in the additional one of the plurality of interactive virtual folders.

13. The computer-implemented method of claim 8, further comprising:
receiving, by the document management hub, selections of multiple virtual
folders from the plurality of virtual folders; and
receiving, by the document management hub, an additional query to determine
whether the at least one digital content instance associated with the electronic document is in each of the multiple virtual folders that are selected.

14. The computer-implemented method of claim 13, wherein the outputting
of the metadata of the electronic document for presenting on the user interface comprises:
presenting on the user interface, responsive to the document management hub executing one or more instructions and accessing the metadata, the at least one digital content instance associated with the electronic document that is in each of the multiple virtual folders that are selected.

15. The computer-implemented method of claim 8, further comprising modifying
content of the electronic document.

16. The computer-implemented method of claim 15, further comprising:
presenting on the user interface of a first device responsive to the modifying, by
the document management hub, the electronic document as including the content that is modified; and
presenting on an additional user interface of a second device responsive to the modifying, by the document management hub, the electronic document as including the content that is modified.

17. The computer-implemented method of claim 1, further comprising:
receiving, at the electronic document, a request for including the electronic
document as part of a document organizational structure specific to an additional electronic document; and
organizing by a document management hub, automatically and without user-intervention, the electronic document according to the document organizational structure specific to the additional electronic document.

18. The computer-implemented method of claim 1, further comprising:
detecting, by a document management hub, a context associated with the electronic document; and
organizing by the document management hub, automatically and without user intervention, the electronic document as part of a context-specific organizational structure based on the context associated with the electronic document.

19. The computer-implemented method of claim 18, wherein the context
corresponds to an employer-environment, a school-environment, or a home environment.

20. The computer-implemented method of claim 19, wherein the context-specific organizational structure corresponds to a home-specific digital filing structure.

21. The computer-implemented method of claim 20, wherein the receiving of the query to access the electronic document comprises:
receiving, at the electronic document, a content presentation format and a search term related to the electronic document, the content presentation format being a table view.

22. The computer-implemented method of claim 21, wherein the generating of
the framework for presenting the electronic document comprising:
generating, by a document management hub, a visual layout including a plurality of interactive categories and a plurality of interactive icons; and
arranging, by the document management hub, a first subset of the plurality of
interactive icons in relation to a first interactive category of the plurality of interactive categories and a second subset of the plurality of interactive icons in relation to a second interactive category of the plurality of categories, wherein the first subset is different from the second subset.

23. The computer-implemented method of claim 22, further comprising:
associating, by the document management hub, at least one interactive icon in the first subset and at least one additional interactive icon in the second subset with the electronic document.

24. The computer-implemented method of claim 23, wherein:
the at least one interactive icon in the first subset of the plurality of interactive
icons corresponds to a first pending action specific to the electronic document; and
the at least one additional interactive icon in the second subset of the plurality of interactive icons corresponds to a second pending action specific to the electronic document.

25. The computer-implemented method of claim 24, wherein the first pending
action corresponds to an in-document application and the second pending action corresponds to document circulation.

26. The computer-implemented method of claim 24, wherein the first pending
action corresponds to obtaining a signature on the electronic document and the second pending action corresponds to obtaining initials on the electronic document.

27. The computer-implemented method of claim 1, wherein the electronic document comprises embedded decision logic programmed to autonomously process requests and determine access permissions.

28. The computer-implemented method of claim 1, wherein the electronic document autonomously updates its content and metadata in real time in response to user interactions or changes in the framework, and such updates are immediately reflected across all user interfaces.

29. The computer-implemented method of claim 1, wherein the electronic document is configured to interact with an artificial intelligence agent using a specialized protocol.

30. The computer-implemented method of claim 29, wherein the specialized protocol comprises a machine communication protocol.

31. The computer-implemented method of claim 1, wherein the electronic document comprises an artificial intelligence application programming interface configured to support artificial intelligence agents in at least one of querying, analyzing, or interacting with the electronic document in a structured manner.

32. The computer-implemented method of claim 1, wherein the electronic document enforces role-based access control on artificial intelligence agents.

33. The computer-implemented method of claim 1, wherein the electronic document is configured to manage artificial intelligence agent access to the electronic document by autonomously evaluating permissions for one or more specific portions of the electronic document.

34. The computer-implemented method of claim 1, wherein the electronic document is configured to maintain an audit trail for interactions between artificial intelligence agents and the electronic document by recording which agents accessed which portions of the electronic document and for what purpose.

35. A system comprising:
a document management hub including at least one physical processor and
physical memory comprising computer-executable instructions that, when executed by the at least one physical processor, cause the physical processor to:
receive, at an electronic document provisioned as digital infrastructure that maintains a single authoritative version of the electronic document, a query to access the electronic document;
generate, using the query, a framework for presenting the electronic document; and
output metadata of the electronic document for presenting on a user interface, according to the framework, at least one digital content instance of the electronic document.

36. A non-transitory computer-readable medium comprising computer-executable instructions that, when executed by at least one of one or more processors of a computing device, cause the computing device to:
receive a query to access an electronic document provisioned as digital infrastructure that maintains a single authoritative version of the electronic document;
generate, using the query, a framework for presenting the electronic document; and
output metadata of the electronic document for presenting on a user interface, according to the framework, at least one digital content instance of the electronic document.
